(19) United States
(12) Patent Application Publication
(10) Pub. No.: US 2023/0385642 A1
(43) Pub. Date: Nov. 30, 2023

(54) MODEL TRAINING METHOD AND APPARATUS

(71) Applicant: HUAWEI TECHNOLOGIES CO., LTD., Shenzhen (CN)

(72) Inventors: Yucong ZHOU, Shenzhen (CN); Zhao ZHONG, Beijing (CN)

(21) Appl. No.: 18/446,294

(22) Filed: Aug. 8, 2023

Related U.S. Application Data
(63) Continuation of application No. PCT/CN2022/074940, filed on Jan. 29, 2022.

(30) Foreign Application Priority Data
Feb. 10, 2021 (CN) 202110183936.2

(51) Int. Cl. G06N 3/08; G06N 3/0464

(52) U.S. Cl. CPC G06N 3/08; G06N 3/0464

(57) ABSTRACT

This application discloses a model training method, which may be applied to the field of artificial intelligence. The method includes: obtaining a first neural network model; replacing a first convolutional layer in the first neural network model with a linear operation to obtain a plurality of second neural network models; and performing model training on a plurality of second neural network models, to obtain a neural network model with a highest model precision in a plurality of trained second neural network models. In this application, a convolutional layer in a to-be-trained neural network is replaced with a linear operation equivalent to a convolutional layer. A manner with highest precision is selected from a plurality of replacement manners, to improve precision of a trained model.

### CROSS-REFERENCE TO RELATED APPLICATIONS

This application is a continuation of International Application No. PCT/CN2022/074940, filed on Jan. 29, 2022, which claims priority to Chinese Patent Application No. 202110183936.2, filed on Feb. 10, 2021. The disclosures of the aforementioned applications are hereby incorporated by reference in their entirety.

### TECHNICAL FIELD

This application relates to the field of artificial intelligence, and in particular, to a model training method and apparatus.

### BACKGROUND

Artificial intelligence (AI) is a theory, a method, a technology, and an application system that simulates, extends, and expands human intelligence by using a digital computer or a machine controlled by a digital computer, to perceive an environment, obtain knowledge, and achieve an optimal result based on the knowledge. In other words, artificial intelligence is a branch of computer science, and is intended to understand the essence of intelligence and produce a new intelligent machine that can react in a manner similar to human intelligence. Artificial intelligence is to study design principles and implementation methods of various intelligent machines, so that the machines have perception, inference, and decision-making functions.

To improve model precision during model training, an over-parameterized training method may be used. In an embodiment, additional parameters and calculation may be introduced during training based on an original model, to affect a model training process and achieve a purpose of improving the model precision. An ACNet (asymmetric convolutional network) is an over-parameterized training method. In a training process, an original 3×3 convolution is replaced with a sum of three convolutions: 3×3, 1×3, and 3×1. However, the ACNet has only one specified over-parameterized form, and improvement on model performance is limited.

### SUMMARY

According to a first aspect, this application provides a model training method. The method includes:

A first neural network model is obtained, where the first neural network model includes a first convolutional layer. A training device may replace some or all convolutional layers in the first neural network model with linear operations. A replaced convolutional layer object may be the first convolutional layer included in the first neural network model. In an embodiment, the first neural network model may include a plurality of convolutional layers, and the first convolutional layer is one of the plurality of convolutional layers. Replaced convolutional layer objects may be a plurality of convolutional layers included in the first neural network model, and the first convolutional layer is one of the plurality of convolutional layers.

A plurality of second neural network models are obtained based on the first neural network model, where each second neural network model is obtained by replacing the first convolutional layer in the first neural network model with the linear operation, and the linear operation is equivalent to one convolutional layer.

In this embodiment of this application, “equivalent” indicates a relationship between two operation units. In an embodiment, two operation units in different forms obtain same processing results when processing any same data. For the two operation units, one operation unit may be converted into an operation unit of another form through mathematical operation derivation. For this embodiment of this application, a sub-linear operation included in the linear operation may be converted into a form of a convolutional layer through mathematical operation derivation. The convolutional layer obtained through the conversion and the linear operation obtain same processing results when processing same data.

The linear operation includes a plurality of sub-linear operations. The sub-linear operations herein may be basic linear operations instead of an operation formed by combining a plurality of basic linear operations. The linear operation herein refers to an operation formed by combining a plurality of basic linear operations. For example, an operation type of the sub-linear operation may be but is not limited to an addition operation, a null operation, an identity operation, a convolution operation, a batch normalization BN operation, or a pooling operation. Correspondingly, the linear operation may be a combination of sub-linear operations of at least one type of the addition operation, the null operation, the identity operation, the convolution operation, the batch normalization BN operation, and the pooling operation. It should be understood that the combination herein means that a quantity of the sub-linear operations is greater than or equal to 2, there is a connection relationship between the sub-linear operations, and there is no isolated sub-linear operation. That there is the connection relationship means that an output of one sub-linear operation is used as an input of another sub-linear operation (other than a sub-linear operation on an output side of the linear operation, where an output of the sub-linear operation is used as an output of the linear operation).

It should be understood that the linear operation in each second neural network model is different from the first convolutional layer, and linear operations included in different second neural network models are different.

Model training is performed on the plurality of second neural network models, to obtain a target neural network model, where the target neural network model is a neural network model with highest model precision in a plurality of trained second neural network models.

When the second neural network models are trained, model precisions (or referred to as verification precisions) of trained second neural network models may be obtained. A second neural network model with highest model precision may be selected from the plurality of trained second neural network models based on the model precisions of the trained second neural network models.

In the foregoing manner, a convolutional layer in a to-be-trained neural network is replaced with a linear operation that may be equivalent to a convolutional layer. A manner with highest precision is selected from a plurality of replacement manners, to improve precision of a trained model.

In an embodiment, a receptive field of the convolutional layer equivalent to the linear operation is less than or equal to a receptive field of the first convolutional layer.

To enable the linear operation to be equivalent to one convolutional layer, the plurality of sub-linear operations included in the linear operation include at least one convolution operation. In a subsequent model inference process, to avoid reducing a speed of an inference phase or increasing resource consumption of the inference phase, a linear operation is not used for model inference, but a convolutional layer (which may be referred to as a second convolutional layer in a subsequent embodiment) equivalent to the linear operation is used for the model inference. It is necessary to ensure that a receptive field of the convolutional layer equivalent to the linear operation is less than or equal to a receptive field of the first convolutional layer.

In an embodiment, the linear operation includes a plurality of operation branches. An input of each operation branch is an input of the linear operation. To be specific, each operation branch is used to process input data of the linear operation. Each operation branch includes at least one serial sub-linear operation, and an equivalent receptive field of the at least one serial sub-linear operation is less than or equal to the receptive field of the first convolutional layer.

Alternatively, the linear operation includes one operation branch. The operation branch is used to process input data of the linear operation. The operation branch includes at least one serial sub-linear operation, and an equivalent receptive field of the at least one serial sub-linear operation is less than or equal to the receptive field of the first convolutional layer.

An input and an output of the linear operation are two endpoints, and a data path between the two endpoints may be an operation branch. A start point of the operation branch is the input of the linear operation, and an end point of the operation branch is the output of the linear operation. In an implementation, the linear operation may include the plurality of operation branches. Each operation branch is used to process the input data of the linear operation. In other words, a start point of each operation branch is an input of the linear operation. In this way, an input of a sub-linear operation that is in each operation branch and that is closest to the input of the linear operation is input data of the linear operation. In other words, each operation branch is used to process the input data of the linear operation, and each operation branch includes at least one serial sub-linear operation. In other words, the linear operation may be represented as a computational graph. In the computational graph, input sources and flow directions of output data of the sub-linear operations are defined. In the computational graph, any path from the input to the output may be defined as an operation branch of the linear operation.

For a single sub-linear operation, for example, a receptive field of k*k convolution or pooling is k, and receptive fields of an addition operation and a BN operation are 1. That an equivalent receptive field of an operation branch is k is defined as: each output of the operation branch is affected by k*k inputs.

To ensure that the equivalent receptive field of the linear operation is less than or equal to the receptive field of the first convolutional layer, the equivalent receptive field of each operation branch in the linear operation is required to be less than or equal to the receptive field of the first convolutional layer. In an implementation, the linear operation may include only one operation branch. The operation branch is used to process input data of the linear operation. The operation branch includes at least one serial sub-linear operation. In this case, an equivalent receptive field of the only operation branch included in the linear operation is less than or equal to the receptive field of the first convolutional layer.

In an embodiment, an equivalent receptive field of at least one of the plurality of parallel operation branches is equal to the receptive field of the first convolutional layer.

Alternatively, the equivalent receptive field of the only operation branch included in the linear operation is equal to the receptive field of the first convolutional layer.

In an implementation, the equivalent receptive field of the at least one of the plurality of parallel operation branches is equal to the receptive field of the first convolutional layer. In this case, the receptive field of the linear operation is equal to the receptive field of the first convolutional layer. In this way, the receptive field of the convolutional layer (which is subsequently described as a second convolutional layer) equivalent to the linear operation is equal to the receptive field of the first convolutional layer. The second convolutional layer may be used in a subsequent model inference process. Because the receptive field of the second convolutional layer is the same as the receptive field of the first convolutional layer, on a premise that a size specification of a model used for the inference process is the same as a size specification of a neural network model in which a convolutional layer is not replaced, that is, the speed and the resource consumption of the inference phase remain unchanged, a quantity of training parameters is increased and precision of the model is improved, compared with a case in which the receptive field of the second convolutional layer is less than the receptive field of the first convolutional layer.

In an embodiment, the linear operation in each second neural network model is different from the first convolutional layer, and linear operations included in different second neural network models are different.

In an embodiment, the convolutional layer equivalent to the linear operation and the linear operation obtain same processing results when processing same data.

In an embodiment, the target neural network model includes a trained target linear operation, and the method further includes:
replacing the trained target linear operation in the target neural network model with a second convolutional layer equivalent to the trained target linear operation, to obtain a third neural network model.

Compared with the first convolutional layer, the target linear operation includes a plurality of sub-linear operations. If the target neural network model is directly used for the model inference, the model inference speed is reduced, and the resource consumption required for the model inference is increased. Therefore, in this embodiment, the second convolutional layer equivalent to the trained target linear operation may be obtained. The trained target linear operation in the target neural network model is replaced with the second convolutional layer, to obtain the third neural network model. The third neural network model may be used for the model inference.

The model inference refers to a procedure of using a model to actually process data in a model application process.

It should be understood that, in this embodiment of this application, a training device may complete operations of obtaining the second convolutional layer equivalent to the trained target linear operation, and replacing the trained target linear operation in the target neural network model with the second convolutional layer to obtain the third neural network model. After training is completed, the training device may directly feed back the third neural network model. In an embodiment, the training device may send the third neural network model to a terminal device or a server. In this way, the terminal device or the server may perform model inference based on the third neural network model. Alternatively, before performing the model inference, the terminal device or the server obtains the second convolutional layer equivalent to the trained target linear operation, and replaces the trained target linear operation in the target neural network model with the second convolutional layer, to execute an action of obtaining the third neural network model.

In an embodiment, a size of the second convolutional layer is the same as a size of the first convolutional layer.

To enable a model used for the inference to have a same specification as the first neural network model before the training, the size of the second convolutional layer is required to be the same as the size of the first convolutional layer.

In an implementation, if the receptive field of the target linear operation is equal to the receptive field of the first convolutional layer, the size of the second convolutional layer is the same as the size of the first convolutional layer.

In an implementation, if the receptive field of the target linear operation is less than the receptive field of the first convolutional layer, a size of an equivalent convolutional layer obtained through calculation is less than the size of the first convolutional layer. In this case, a zero-padding operation may be performed on the equivalent convolutional layer obtained through calculation, to obtain the second convolutional layer with a size the same as the size of the first convolutional layer.

In an embodiment, the method further includes:
fusing, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

If the sub-linear operation is not an operation directly connected to an input side of the linear operation, a fusion parameter of the sub-linear operation is an operation parameter of the sub-linear operation.

If the sub-linear operation is not an operation directly connected to an input side of the linear operation, a fusion parameter of the sub-linear operation is obtained based on a fusion parameter of an adjacent sub-linear operation in the front, or is obtained based on the fusion parameter of the adjacent sub-linear operation in the front and an operation parameter of the sub-linear operation.

Each sub-linear operation may be fused, based on the data processing sequence of the plurality of sub-linear operations, into the adjacent sub-linear operation that follows the sub-linear operation in the sequence, until the fusion of the last sub-linear operation (a sub-linear operation closest to an output) is completed.

It should be understood that an input of a sub-linear operation is determined depending on a corresponding output obtained by another sub-linear operation through data processing. For example, an output of an operation A is an input of an operation B, and an output of the operation B is an input of an operation C. In this case, data processing of the operation C may be performed by the operation C only after the operation A and the operation B complete data processing and obtain corresponding outputs. Therefore, parameter fusion of the sub-linear operation is performed only after parameter fusion of the sub-linear operations is completed.

It should be understood that inputs of some sub-linear operations are determined without depending on corresponding outputs obtained by some other sub-linear operations through data processing. For example, an input of an operation A1 is an input of an overall linear operation, an output of the operation A1 is an input of an operation A2, an output of the operation A2 is an input of an operation B, an input of an operation C1 is an input of the overall linear operation, an output of the operation C1 is an input of an operation C2, and an output of the operation C2 is also an input of the operation B. In this case, there is no strict constraint on a time sequence of processing data by the operation A1 and processing data by the operation C1. A process of fusing the operation A1 into the operation A2 may be performed before or after a process of fusing the operation C1 into the operation C2, or the two processes may be performed at the same time.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In this embodiment, the first sub-linear operation and the second sub-linear operation may be any adjacent sub-linear operations of the trained target linear operation. The second sub-linear operation is a sub-linear operation that follows the first sub-linear operation in the sequence. The first sub-linear operation includes a first operation parameter. The first sub-linear operation is used to perform, based on the first operation parameter, processing corresponding to an operation type of the first sub-linear operation on input data of the first sub-linear operation. The second sub-linear operation includes a second operation parameter. The second sub-linear operation is used to perform, based on the second operation parameter, processing corresponding to an operation type of the second sub-linear operation on input data of the second sub-linear operation. The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

For a linear operation of a trained target neural network, a fusion parameter=fusion (an output node). A fusion process is performed on each linear operation in a model, and a fully fused model is ultimately obtained. A structure of the model is the same as a structure of the original model. Therefore, a speed and resource consumption in an inference phase remain unchanged. In addition, the model before fusion and the model obtained through fusion are mathematically equivalent. Therefore, precision of the model obtained through fusion is the same as precision of the model before fusion.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

According to a second aspect, this application provides a model training method. The method includes:

A first neural network model is obtained, where the first neural network model includes a first convolutional layer, and the first neural network model is used to implement a target task.

A target linear operation for replacing the first convolutional layer is determined based on at least one piece of the following information, where the information includes a network structure of the first neural network model, the target task, and a location of the first convolutional layer in the first neural network model, and the target linear operation is equivalent to one convolutional layer.

Different linear operations may be selected for neural network models of different network structures, neural network models that implement different target tasks, and convolutional layers at different locations in the neural network models, so that model precision of a trained neural network model in which the convolutional layer is replaced is high.

The target linear operation may be determined based on the network structure of the first neural network model and/or the location of the first convolutional layer in the first neural network model. In an embodiment, a structure of the target linear operation may be determined based on the network structure of the first neural network model. The network structure of the first neural network model may be a quantity of sub-network layers included in the first neural network model, types of the sub-network layers, a connection relationship between the sub-network layers, and the location of the first convolutional layer in the first neural network model. The structure of the target linear operation may be a quantity of sub-linear operations included in the target linear operation, types of the sub-linear operations, and a connection relationship between the sub-linear operations. For example, convolutional layers of the neural network models of different network structures may be replaced with linear operations in a model search manner. The neural network models in which the convolutional layers are replaced are trained, to determine optimal or better linear operations corresponding to the convolutional layers in the network structures of the neural network models. The optimal or better linear operation means that precision of a model obtained by training the neural network model in which the convolutional layer is replaced is high. After the first neural network model is obtained, based on the network structure of the first neural network model, a neural network model with a same or similar structure may be selected from neural network models obtained through pre-searching. A linear operation corresponding to a convolutional layer in the neural network model with a same or similar structure is determined as the target linear operation, where a relative location of the foregoing “a convolutional layer” in the neural network model with a same or similar structure is the same as or similar to a relative location of the first convolutional layer in the first neural network model.

The target linear operation may be determined based on the network structure of the first neural network model and the target task implemented by the first neural network model. This is similar to the foregoing manner of performing determining based on the network structure of the first neural network model. Convolutional layers of neural network models that are of different network structures and that implement different target tasks may be replaced with linear operations in a model search manner. The neural network models in which the convolutional layers are replaced are trained, to determine optimal or better linear operations corresponding to the convolutional layers in the network structures of the neural network models. The optimal or better linear operation means that precision of a model obtained by training the neural network model in which the convolutional layer is replaced is high.

The target linear operation may be determined based on the target task implemented by the first neural network model. This is similar to the foregoing manner of performing determining based on the network structure of the first neural network model. Convolutional layers of neural network models that implement different target tasks may be replaced with linear operations in a model search manner. The neural network models in which the convolutional layers are replaced are trained, to determine optimal or better linear operations corresponding to the convolutional layers in the network structures of the neural network models. The optimal or better linear operation means that precision of a model obtained by training the neural network model in which the convolutional layer is replaced is high.

It should be understood that the foregoing manner of determining the target linear operation based on the network structure of the first neural network model and/or the target task is merely an example. Another manner may be used for implementation, provided that model precision of a first neural network model in which the convolutional layer is replaced (that is, a second neural network model) is high. Manners for determining a specific structure and a determining manner of the target linear operation are not limited.

The second neural network model is obtained based on the first neural network model, where the second neural network model is obtained by replacing the first convolutional layer in the first neural network model with the target linear operation.

Model training is performed on the second neural network model, to obtain a target neural network model.

In this embodiment, a convolutional layer in a to-be-trained neural network is replaced with the target linear operation. The structure of the target linear operation is determined based on the structure of the first neural network model and/or the target task. Compared with a linear operation for replacing a convolutional layer in the existing technology, the linear operation in this embodiment has a structure that is more applicable to the first neural network model and is more flexible. Different linear operations may be designed for different model structures and task types, thereby improving precision of a trained model.

In an embodiment, the target linear operation includes a plurality of sub-linear operations. The target linear operation includes M operation branches. An input of each operation branch is an input of the target linear operation. The M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different.

Compared with a structure of a linear operation for replacing a convolutional layer in the existing technology, the structure of the target linear operation provided in this embodiment is more complex, and may improve precision of a trained model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the target neural network model includes a trained target linear operation, and the method further includes:
replacing the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the method further includes:
fusing, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

In addition, this application provides a model training method, where the method includes:
obtaining a first neural network model, where the first neural network model includes a first convolutional layer;
obtaining a plurality of second neural network models based on the first neural network model, where each second neural network model is obtained by replacing the first convolutional layer in the first neural network model with a target linear operation; the target linear operation is equivalent to one convolutional layer; the target linear operation includes a plurality of sub-linear operations; the target linear operation includes M operation branches; an input of each operation branch is an input of the target linear operation; and the M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different; and
performing model training on the second neural network model, to obtain a target neural network model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the target neural network model includes a trained target linear operation, and the method further includes:
replacing the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the method further includes:
fusing, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

This application provides the model training method. The method includes: obtaining the first neural network model, where the first neural network model includes the first convolutional layer; obtaining the plurality of second neural network models based on the first neural network model, where each second neural network model is obtained by replacing the first convolutional layer in the first neural network model with the target linear operation; the target linear operation is equivalent to one convolutional layer; the target linear operation includes a plurality of sub-linear operations; the target linear operation includes M operation branches; an input of each operation branch is an input of the target linear operation; and the M operation branches meet at least one of the following conditions: an input of at least one of a plurality of sub-linear operations included in the M operation branches is an output of a plurality of sub-linear operations of the plurality of sub-linear operations, quantities of sub-linear operations included between at least two of the M operation branches are different, or operation types of sub-linear operations included between at least two of the M operation branches are different; and performing model training on the second neural network model, to obtain the target neural network model. Compared with a structure of a linear operation for replacing a convolutional layer in the existing technology, the structure of the target linear operation provided in this embodiment is more complex, and may improve precision of a trained model.

According to a third aspect, this application provides a model training apparatus. The apparatus includes:
an obtaining module, configured to: obtain a first neural network model, where the first neural network model includes a first convolutional layer, and
obtain a plurality of second neural network models based on the first neural network model, where each second neural network model is obtained by replacing the first convolutional layer in the first neural network model with the linear operation, and the linear operation is equivalent to one convolutional layer; and
a model training module, configured to perform model training on the plurality of second neural network models, to obtain a target neural network model, where the target neural network model is a neural network model with highest model precision in a plurality of trained second neural network models.

In the foregoing manner, a convolutional layer in a to-be-trained neural network is replaced with a linear operation that may be equivalent to a convolutional layer. A manner with highest precision is selected from a plurality of replacement manners, to improve precision of a trained model.

In an embodiment, a receptive field of the convolutional layer equivalent to the linear operation is less than or equal to a receptive field of the first convolutional layer.

To enable the linear operation to be equivalent to one convolutional layer, the plurality of sub-linear operations included in the linear operation include at least one convolution operation. In a subsequent model inference process, to avoid reducing a speed of an inference phase or increasing resource consumption of the inference phase, a linear operation is not used for model inference, but a convolutional layer (which may be referred to as a second convolutional layer in a subsequent embodiment) equivalent to the linear operation is used for the model inference. It is necessary to ensure that a receptive field of the convolutional layer equivalent to the linear operation is less than or equal to a receptive field of the first convolutional layer.

In an embodiment, the linear operation includes a plurality of operation branches. An input of each operation branch is an input of the linear operation. Each operation branch includes at least one serial sub-linear operation, and an equivalent receptive field of the at least one serial sub-linear operation is less than or equal to the receptive field of the first convolutional layer.

Alternatively, the linear operation includes one operation branch. The operation branch is used to process input data of the linear operation. The operation branch includes at least one serial sub-linear operation, and an equivalent receptive field of the at least one serial sub-linear operation is less than or equal to the receptive field of the first convolutional layer.

In an implementation, the equivalent receptive field of the at least one of the plurality of parallel operation branches is equal to the receptive field of the first convolutional layer. In this case, the receptive field of the linear operation is equal to the receptive field of the first convolutional layer. In this way, the receptive field of the convolutional layer (which is subsequently described as a second convolutional layer) equivalent to the linear operation is equal to the receptive field of the first convolutional layer. The second convolutional layer may be used in a subsequent model inference process. Because the receptive field of the second convolutional layer is the same as the receptive field of the first convolutional layer, on a premise that a size specification of a model used for the inference process is the same as a size specification of a neural network model in which a convolutional layer is not replaced, that is, the speed and the resource consumption of the inference phase remain unchanged, a quantity of training parameters is increased and precision of the model is improved, compared with a case in which the receptive field of the second convolutional layer is less than the receptive field of the first convolutional layer.

In an embodiment, the linear operation in each second neural network model is different from the first convolutional layer, and linear operations included in different second neural network models are different.

In an embodiment, the convolutional layer equivalent to the linear operation and the linear operation obtain same processing results when processing same data.

In an embodiment, the target neural network model includes a trained target linear operation, and the obtaining module is configured to:
replace the trained target linear operation in the target neural network model with a second convolutional layer equivalent to the trained target linear operation, to obtain a third neural network model.

Compared with the first convolutional layer, the target linear operation includes a plurality of sub-linear operations. If the target neural network model is directly used for the model inference, the model inference speed is reduced, and the resource consumption required for the model inference is increased. Therefore, in this embodiment, the second convolutional layer equivalent to the trained target linear operation may be obtained. The trained target linear operation in the target neural network model is replaced with the second convolutional layer, to obtain the third neural network model. The third neural network model may be used for the model inference.

The model inference refers to a procedure of using a model to actually process data in a model application process.

It should be understood that, in this embodiment of this application, a training device may complete operations of obtaining the second convolutional layer equivalent to the trained target linear operation, and replacing the trained target linear operation in the target neural network model with the second convolutional layer to obtain the third neural network model. After training is completed, the training device may directly feed back the third neural network model. In an embodiment, the training device may send the third neural network model to a terminal device or a server. In this way, the terminal device or the server may perform model inference based on the third neural network model. Alternatively, before performing the model inference, the terminal device or the server obtains the second convolutional layer equivalent to the trained target linear operation, and replaces the trained target linear operation in the target neural network model with the second convolutional layer, to execute an action of obtaining the third neural network model.

In an embodiment, a size of the second convolutional layer is the same as a size of the first convolutional layer.

To enable a model used for the inference to have a same specification as the first neural network model before the training, the size of the second convolutional layer is required to be the same as the size of the first convolutional layer.

In an implementation, if the receptive field of the target linear operation is equal to the receptive field of the first convolutional layer, the size of the second convolutional layer is the same as the size of the first convolutional layer.

In an implementation, if the receptive field of the target linear operation is less than the receptive field of the first convolutional layer, a size of an equivalent convolutional layer obtained through calculation is less than the size of the first convolutional layer. In this case, a zero-padding operation may be performed on the equivalent convolutional layer obtained through calculation, to obtain the second convolutional layer with a size the same as the size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusion module is configured to:
obtain a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtain a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

According to a fourth aspect, this application provides a model training apparatus. The apparatus includes:
an obtaining module, configured to: obtain a first neural network model, where the first neural network model includes a first convolutional layer,
determine, based on at least one piece of the following information, a target linear operation for replacing the first convolutional layer, where the information includes a network structure of the first neural network model, the target task, and a location of the first convolutional layer in the first neural network model, and the target linear operation is equivalent to one convolutional layer, and
obtain a second neural network model based on the first neural network model, where the second neural network model is obtained by replacing the first convolutional layer in the first neural network model with the target linear operation; and
a model training module, configured to perform model training on the second neural network model, to obtain a target neural network model.

In this embodiment, a convolutional layer in a to-be-trained neural network is replaced with the target linear operation. The structure of the target linear operation is determined based on the structure of the first neural network model and/or the target task. Compared with a linear operation for replacing a convolutional layer in the existing technology, the linear operation in this embodiment has a structure that is more applicable to the first neural network model and is more flexible. Different linear operations may be designed for different model structures and task types, thereby improving precision of a trained model.

In an embodiment, the target linear operation includes a plurality of sub-linear operations. The target linear operation includes M operation branches. An input of each operation branch is an input of the target linear operation. The M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different.

Compared with a structure of a linear operation for replacing a convolutional layer in the existing technology, the structure of the target linear operation provided in this embodiment is more complex, and may improve precision of a trained model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the obtaining module is configured to replace the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusion module is configured to: obtain a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtain a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

An embodiment of this application further provides a model training apparatus. The apparatus includes:
an obtaining module, configured to: obtain a first neural network model, where the first neural network model includes a first convolutional layer, and
obtain a plurality of second neural network models based on the first neural network model, where each second neural network model is obtained by replacing the first convolutional layer in the first neural network model with a target linear operation; the target linear operation is equivalent to one convolutional layer; the target linear operation includes a plurality of sub-linear operations; the target linear operation includes M operation branches; an input of each operation branch is an input of the target linear operation; and the M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different; and
a model training module, configured to perform model training on the second neural network model, to obtain a target neural network model.

Compared with a structure of a linear operation for replacing a convolutional layer in the existing technology, the structure of the target linear operation provided in this embodiment is more complex, and may improve precision of a trained model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the target neural network model includes a trained target linear operation, and the obtaining module is configured to:
replace the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

According to a fifth aspect, an embodiment of this application provides a model training apparatus. The model training apparatus may include a memory, a processor, and a bus system. The memory is configured to store a program, and the processor is configured to execute the program in the memory, to perform any one of the first aspect, the third aspect, and the optional method thereof.

According to a sixth aspect, an embodiment of this application provides a computer-readable storage medium. The computer-readable storage medium stores a computer program. When the computer program is run on a computer, the computer is enabled to perform any one of the first aspect, the third aspect, and the optional method thereof.

According to a seventh aspect, an embodiment of this application provides a computer program, including code. When the code is executed, the computer program is used to implement any one of the first aspect, the third aspect, and the optional method thereof.

According to an eighth aspect, this application provides a chip system. The chip system includes a processor, configured to support an execution device or a training device to implement functions in the foregoing aspects, for example, sending or processing data or information in the foregoing methods. In a possible design, the chip system further includes a memory. The memory is configured to store program instructions and data that are necessary for the execution device or the training device. The chip system may include a chip, or may include a chip and another discrete component.

An embodiment of this application provides a model training method. The method includes: obtaining a first neural network model, where the first neural network model includes a first convolutional layer; obtaining a plurality of second neural network models based on the first neural network model, where each second neural network model is obtained by replacing the first convolutional layer in the first neural network model with a linear operation, and the linear operation is equivalent to a convolutional layer; and performing model training on the plurality of second neural network models to obtain a target neural network model, where the target neural network model is a neural network model with highest model precision in a plurality of trained second neural network models. In the foregoing manner, a convolutional layer in a to-be-trained neural network is replaced with a linear operation that may be equivalent to a convolutional layer. A manner with highest precision is selected from a plurality of replacement manners, to improve precision of a trained model.

### BRIEF DESCRIPTION OF DRAWINGS

FIG. 1 is a schematic diagram of a structure of a main framework of artificial intelligence;

FIG. 2 is a schematic diagram of a convolutional neural network according to an embodiment of this application;

FIG. 3 is a schematic diagram of a convolutional neural network according to an embodiment of this application;

FIG. 4 is a schematic diagram of an architecture of a system according to an embodiment of this application;

FIG. 5 is a schematic diagram of an embodiment of a model training method according to an embodiment of this application;

FIG. 6a is a schematic diagram of a linear operation according to an embodiment of this application;

FIG. 6b is a schematic diagram of a linear operation according to an embodiment of this application;

FIG. 6c is a schematic diagram of a linear operation according to an embodiment of this application;

FIG. 7 is a schematic diagram of a receptive field of a convolutional layer according to an embodiment of this application;

FIG. 8 is a schematic diagram of a receptive field of a convolutional layer according to an embodiment of this application;

FIG. 9 is a schematic diagram of a convolutional layer according to an embodiment of this application;

FIG. 10 is a schematic diagram of a convolution kernel according to an embodiment of this application;

FIG. 11 is a schematic diagram of fusion of linear operations according to an embodiment of this application;

FIG. 12 is a schematic diagram of replacement of a linear operation according to an embodiment of this application;

FIG. 13 is a schematic diagram of a linear operation according to an embodiment of this application;

FIG. 14 is a schematic diagram of a zero-padding operation according to an embodiment of this application;

FIG. 15a is a schematic diagram of an application scenario of a model training method according to an embodiment of this application;

FIG. 15b is a schematic diagram of an application scenario of a model training method according to an embodiment of this application;

FIG. 16a is a schematic diagram of an application scenario of a model training method according to an embodiment of this application;

FIG. 16b is a schematic diagram of an embodiment of a model training method according to an embodiment of this application;

FIG. 17 is a schematic diagram of a model training apparatus according to an embodiment of this application;

FIG. 18 is a schematic diagram of a structure of an execution device according to an embodiment of this application;

FIG. 19 is a schematic diagram of a structure of a training device according to an embodiment of this application; and

FIG. 20 is a schematic diagram of a structure of a chip according to an embodiment of this application.

### DESCRIPTION OF EMBODIMENTS

The following describes embodiments of the present disclosure with reference to the accompanying drawings in embodiments of the present disclosure. Terms used in embodiments of the present disclosure are merely intended to explain specific embodiments of the present disclosure, and are not intended to limit the present disclosure.

The following describes embodiments of this application with reference to the accompanying drawings. A person of ordinary skill in the art may learn that, with development of technologies and emergence of a new scenario, the technical solutions provided in embodiments of this application are also applicable to a similar technical problem.

In the specification, claims, and accompanying drawings of this application, the terms such as “first” and “second” are intended to distinguish between similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “have” and any other variants thereof are intended to cover the non-exclusive inclusion, so that a process, method, system, product, or device that includes a list of units is not necessarily limited to those units, but may include other units that are not expressly listed or are inherent to such a process, method, product, or device.

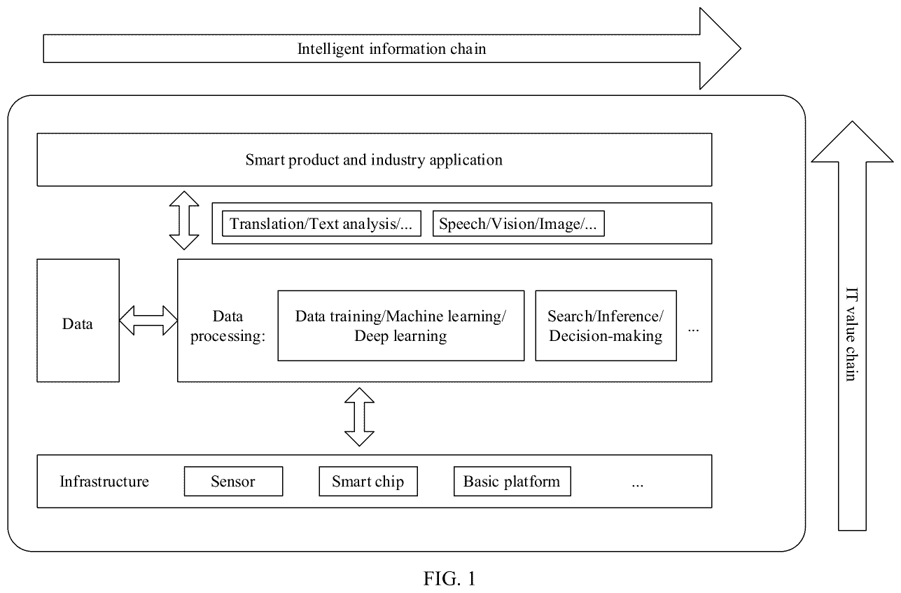

An overall working procedure of an artificial intelligence system is first described with reference to FIG. 1. FIG. 1 is a schematic diagram of a structure of an artificial intelligence main framework. The following describes the artificial intelligence main framework from two dimensions: an “intelligent information chain” (a horizontal axis) and an “IT value chain” (a vertical axis). The “intelligent information chain” reflects a process from obtaining data to processing the data. For example, the process may be a general process including intelligent information perception, intelligent information representation and formation, intelligent inference, intelligent decision-making, and intelligent execution and output. In this process, the data undergoes a refinement process of “data-information-knowledge-intelligence”. The “IT value chain” reflects values brought by artificial intelligence to the information technology industry from an underlying infrastructure and information (which provides and processes technology implementations) of artificial intelligence to an industrial ecology process of the system.

(1) Infrastructure

The infrastructure provides computing capability support for the artificial intelligence system, implements communication with the external world, and implements support by using basic platforms. The infrastructure communicates with the outside by using sensors. A computing capability is provided by intelligent chips (hardware acceleration chips such as a CPU, an NPU, a GPU, an ASIC, and an FPGA). The basic platforms include related platforms, for example, a distributed computing framework and network, for assurance and support. The basic platforms may include a cloud storage and computing network, an interconnection network, and the like. For example, the sensor communicates with the outside to obtain data, and the data is provided to an intelligent chip for computing, where the intelligent chip is in a distributed computing system provided by the basic platform.

(2) Data

Data at an upper layer of the infrastructure indicates a data source in the field of artificial intelligence. The data relates to a graph, an image, speech, and text, and further relates to Internet of things data of a conventional device, which includes service data of an existing system, and perception data such as force, displacement, a liquid level, a temperature, and humidity.

(3) Data Processing

Data processing usually includes data training, machine learning, deep learning, searching, inference, decision-making, and the like.

Machine learning and deep learning may be used to perform symbolic and formal intelligent information modeling, extraction, preprocessing, training, and the like on data.

Inference is a process of simulating a human intelligent inference manner and performing machine thinking and problem resolving with formal information based on an inference control policy in a computer or an intelligent system. A typical function is searching and matching.

Decision-making is a process of making a decision after intelligent information is inferred, and usually provides functions such as classification, ranking, and prediction.

(4) General Capability

After data processing mentioned above is performed on the data, some general capabilities may further be formed based on a data processing result. For example, the general capabilities may be an algorithm or a general system for, for example, translation, text analysis, computer vision processing, speech recognition, and image recognition.

(5) Intelligent Product and Industry Application

The intelligent product and industry application are products and applications of the artificial intelligence system in various fields. The intelligent product and industry application involve packaging overall artificial intelligence solutions, to productize and apply intelligent information decision-making. Application fields of the intelligent information decision-making mainly include smart terminals, smart transportation, smart health care, autonomous driving, safe city, and the like.

The following describes the method provided in this application from a model training side and a model application side.

The model training method provided in embodiments of this application may be applied to a data processing method such as data training, machine learning, and deep learning, to perform symbolic and formal intelligent information modeling, extraction, preprocessing, training, and the like on training data, to ultimately obtain a trained neural network model (for example, a target neural network model in embodiments of this application). In addition, the target neural network model may be used for model inference, and in an embodiment, input data may be input into the target neural network model to obtain output data.

Embodiments of this application relate to massive application of a neural network. Therefore, for ease of understanding, the following first describes terms and concepts related to the neural network in embodiments of this application.

(1) Neural Network

A neural network may include neurons. The neuron may be an operation unit that uses xs (namely, input data) and an intercept of 1 as an input. An output of the operation unit may be as follows:
s=1, 2, . . . , or n, where n is a natural number greater than 1. Ws is a weight of xs, and b is a bias of the neuron. f indicates an activation function (activation function) of the neuron. The activation function is used for introducing a non-linear characteristic into the neural network, to convert an input signal of the neuron into an output signal. The output signal of the activation function may be used as an input of a next convolutional layer. The activation function may be a sigmoid function. The neural network is a network formed by connecting a plurality of single neurons together. An output of a neuron may be an input of another neuron. An input of each neuron may be connected to a local receptive field of a previous layer to extract a feature of the local receptive field. The local receptive field may be a region including several neurons.

(2) Convolutional neural network (convolutional neural network, CNN) is a deep neural network with a convolutional structure. The convolutional neural network includes a feature extractor including a convolutional layer and a sub-sampling layer. The feature extractor may be considered as a filter. A convolution process may be considered as performing convolution by using a trainable filter and an input image or a convolution feature map (feature map). The convolutional layer is a neuron layer (for example, a first convolutional layer and a second convolutional layer in this embodiment) that performs convolution processing on an input signal in the convolutional neural network. At the convolutional layer of the convolutional neural network, one neuron may be connected only to some adjacent-layer neurons. One convolutional layer usually includes several feature maps, and each feature map may include some neural units that are in a rectangular arrangement. Neural units at a same feature map share a weight, and the weight shared herein is a convolution kernel. Weight sharing may be understood as that an image information extraction manner is irrelevant to a location. A principle implied herein is that statistical information of a part of an image is the same as that of other parts. This means that image information learned in a part can also be used in another part. Therefore, the image information obtained through same learning can be used for all locations in the image. At a same convolutional layer, a plurality of convolution kernels may be used to extract different image information. Usually, a larger quantity of convolution kernels indicates richer image information reflected in a convolution operation.

The convolution kernel may be initialized in a form of a matrix of a random size. In a training process of the convolutional neural network, the convolution kernel may obtain a suitable weight through learning. In addition, benefits directly brought by the weight sharing are that connections between layers of the convolutional neural network are reduced, and an overfitting risk is reduced.

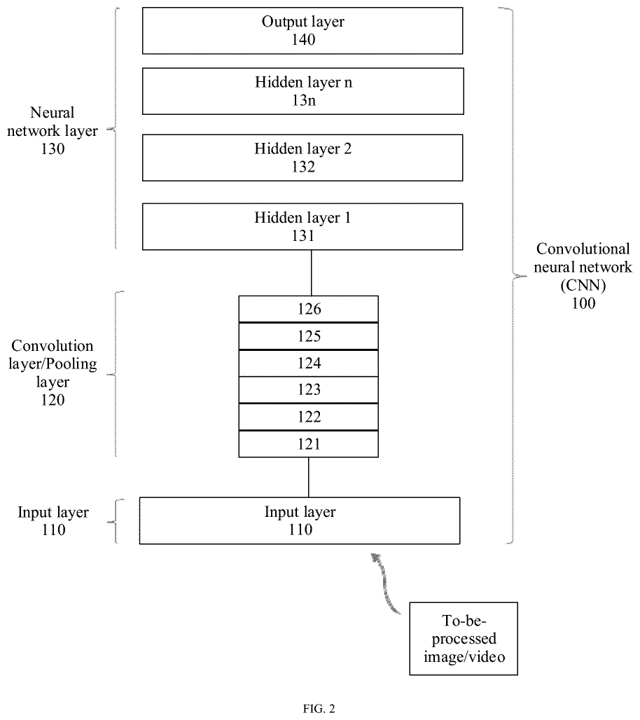

In an embodiment, as shown in FIG. 2, a convolutional neural network (CNN) 100 may include an input layer 110, a convolutional layer/pooling layer 120, and a neural network layer 130, where the pooling layer may be optional.

A structure including the convolutional layer/pooling layer 120 and the neural network layer 130 may be respectively a first convolutional layer and a second convolutional layer described in this application. The input layer 110 is connected to the convolutional layer/pooling layer 120, and the convolutional layer/pooling layer 120 is connected to the neural network layer 130. An output of the neural network layer 130 may be input to an activation layer, and the activation layer may perform non-linear processing on the output of the neural network layer 130.

Convolutional Layer/Pooling Layer 120

Convolutional Layer:

As shown in FIG. 2, for example, the convolutional layer/pooling layer 120 may include layers 121 to 126. In an implementation, the layer 121 is a convolutional layer, the layer 122 is a pooling layer, the layer 123 is a convolutional layer, the layer 124 is a pooling layer, the layer 125 is a convolutional layer, and the layer 126 is a pooling layer. In another implementation, the layer 121 and the layer 122 are convolutional layers, the layer 123 is a pooling layer, the layer 124 and the layer 125 are convolutional layers, and the layer 126 is a pooling layer. In other words, an output of a convolutional layer may be used as an input of a subsequent pooling layer, or may be used as an input of another convolutional layer to continue a convolution operation.

The convolutional layer 121 is used as an example. The convolutional layer 121 may include a plurality of convolution operators. A convolution operator is also referred to as a kernel. In image processing, the convolution operator functions as a filter that extracts specific information from an input image matrix. The convolution operator may be essentially a weight matrix, and the weight matrix is usually predefined. In a process of performing a convolution operation on an image, the weight matrix is usually used to process pixels at a granularity level of one pixel (or two pixels . . . , which depends on a value of a stride (stride)) in a horizontal direction on the input image, to extract a specific feature from the image. A size of the weight matrix should be related to a size of the image. It should be noted that a depth dimension (depth dimension) of the weight matrix is the same as that of the input image. During a convolution operation, the weight matrix extends to an entire depth of the input picture. Therefore, a convolution output of a single depth dimension is generated by performing convolution with a single weight matrix. However, in most cases, a plurality of weight matrices of a same dimension rather than the single weight matrix are used. Outputs of the weight matrices are stacked to form a depth dimension of a convolutional image. Different weight matrices may be used to extract different features of the image. For example, one weight matrix is used to extract edge information of the image, another weight matrix is used to extract a specific color of the image, still another weight matrix is used to blur an unnecessary noise in the image, and the like. Because the plurality of weight matrices have the same dimension, feature maps extracted by using the plurality of weight matrices with the same dimension also have a same dimension. Then, the plurality of extracted feature maps with the same dimension are combined to form an output of the convolution operation.

Weight values in the weight matrices need to be obtained through massive training in actual application. Weight matrices formed by using the weight values obtained through training may be used to extract information from the input image, to help the convolutional neural network 100 to perform correct prediction.

When the convolutional neural network 100 includes a plurality of convolutional layers, a larger quantity of general features are usually extracted at an initial convolutional layer (for example, the convolutional layer 121). The general features may be also referred to as low-level features. As a depth of the convolutional neural network 100 increases, a feature extracted at a more subsequent convolutional layer (for example, the convolutional layer 126) is more complex, for example, a higher-level semantic feature. A feature with higher semantics is more applicable to a to-be-resolved problem.

Pooling Layer:

Because a quantity of training parameters usually needs to be reduced, a pooling layer usually needs to be periodically introduced after a convolutional layer. In other words, for the layers 121 to 126 in the layer 120 shown in FIG. 2, one convolutional layer may be followed by one pooling layer, or a plurality of convolutional layers may be followed by one or more pooling layers.

Neural Network Layer 130

After processing is performed by the convolutional layer/pooling layer 120, the convolutional neural network 100 still cannot output required output information. As described above, at the convolutional layer/pooling layer 120, only a feature is extracted, and parameters resulting from the input image are reduced. However, to generate final output information (required class information or other related information), the convolutional neural network 100 needs to use the neural network layer 130 to generate an output of one required class or outputs of a group of required classes. Therefore, the neural network layer 130 may include a plurality of hidden layers (131, 132, to 13n shown in FIG. 2) and an output layer 140. Parameters included in the plurality of hidden layers may be obtained through pre-training based on related training data of a specific task type. For example, the task type may include image recognition, image classification, super-resolution image reconstruction, and the like.

At the neural network layer 130, the plurality of hidden layers are followed by the output layer 140, that is, the last layer of the entire convolutional neural network 100. The output layer 140 has a loss function similar to a categorical cross-entropy, and the loss function may be used to calculate a prediction error. Once forward propagation (for example, propagation from 110 to 140 in FIG. 2 is forward propagation) of the entire convolutional neural network 100 is completed, backpropagation (for example, propagation from 140 to 110 in FIG. 2 is backpropagation) is started to update a weight value and a deviation of each layer mentioned above, to reduce a loss of the convolutional neural network 100 and an error between a result output by the convolutional neural network 100 through the output layer and an ideal result.

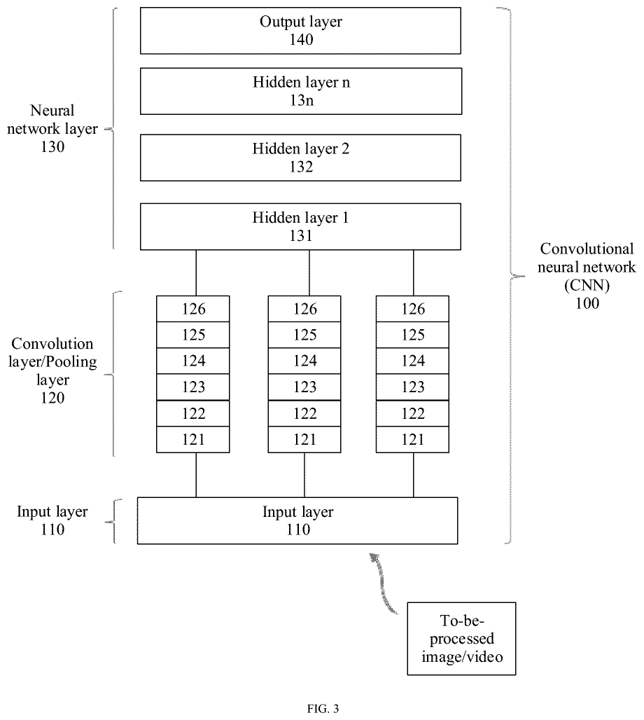

It should be noted that the convolutional neural network 100 shown in FIG. 2 is merely used as an example of a convolutional neural network. During specific application, the convolutional neural network may alternatively exist in a form of another network model, for example, a plurality of parallel convolutional layers/pooling layers shown in FIG. 3. Extracted features are all input to the entire neural network layer 130 for processing.

(3) Deep Neural Network

The deep neural network (deep neural network, DNN), also referred to as a multi-layer neural network, may be understood as a neural network having a plurality of hidden layers. The “plurality of” herein does not have a special measurement criteria. The DNN is divided based on locations of different layers, and a neural network in the DNN may be divided into three types: an input layer, a hidden layer, and an output layer. Generally, the first layer is an input layer, the last layer is an output layer, and a middle layer is a hidden layer. Layers are fully connected. To be specific, any neuron at an i^{th} layer is necessarily connected to any neuron at an (i+1)^{th} layer. Although the DNN seems to be complex, the DNN is actually not complex in terms of work at each layer, and is simply expressed as the following linear relationship expression: \vec{y}=α(W\vec{x}+\vec{b}), where \vec{x} is an input vector, \vec{y} is an output vector, \vec{b} is an offset vector, W is a weight matrix (also referred to as a coefficient), and α( ) is an activation function. At each layer, the output vector \vec{y} is obtained by performing such a simple operation on the input vector \vec{x}. Because there are many layers in the DNN, there are also many coefficients W and offset vectors \vec{b}. Definitions of these parameters in the DNN are as follows. The coefficient W is used as an example. It is assumed that in a three-layer DNN, a linear coefficient from a fourth neuron at a second layer to a second neuron at a third layer is defined as w₂₄³. The superscript 3 represents a layer to which the coefficient W is related, and subscript corresponds to an output third-layer index 2 and an input second-layer index 4. In conclusion, a coefficient from a k^{th} neuron at an (L−1)^{th} layer to a j^{th} neuron at an L^{th} layer is defined as Wⱼₖ^{L}. It should be noted that there is no parameter W at the input layer. In the deep neural network, more hidden layers make the network more capable of depicting a complex case in the real world. Theoretically, a model with more parameters has higher complexity and a larger “capacity”. This indicates that the model can complete a more complex learning task. Training the deep neural network is a process of learning a weight matrix, and a final objective of the training is to obtain a weight matrix of all layers of the trained deep neural network (a weight matrix formed by vectors W at many layers).

(4) Loss Function

In a process of training the deep neural network, because it is expected that an output of the deep neural network is as much as possible close to a predicted value that is actually expected, a predicted value of a current network and a target value that is actually expected may be compared, and then a weight vector of each layer of the neural network is updated based on a difference between the predicted value and the target value (certainly, there is usually an initialization process before the first update, that is, parameters are pre-configured for all layers of the deep neural network). For example, if the predicted value of the network is large, the weight vector is adjusted to decrease the predicted value, and adjustment is continuously performed, until the deep neural network can predict the target value that is actually expected or a value that is close to the target value that is actually expected. Therefore, “how to obtain, through comparison, a difference between the predicted value and the target value” needs to be predefined. This is a loss function (loss function) or an objective function (objective function). The loss function and the objective function are important equations that measure the difference between the predicted value and the target value. The loss function is used as an example. A higher output value (loss) of the loss function indicates a larger difference. Therefore, training of the deep neural network is a process of minimizing the loss as much as possible.

(5) Backpropagation Algorithm

The convolutional neural network may correct a value of a parameter in an initial super-resolution model in a training process according to an error backpropagation (backpropagation, BP) algorithm, so that an error loss of reconstructing the super-resolution model becomes smaller. In an embodiment, an input signal is transferred forward until an error loss occurs at an output, and the parameter in the initial super-resolution model is updated based on backpropagation error loss information, to make the error loss converge. The backpropagation algorithm is an error-loss-centered backpropagation motion intended to obtain a parameter, such as a weight matrix, of an optimal super-resolution model.

(6) Linear Operation

Linearity refers to a proportional and straight-line relationship between quantities, and may be mathematically understood as a function with a first-order derivative constant. The linear operation may be but is not limited to an addition operation, a null operation, an identity operation, a convolution operation, a batch normalization BN operation, and a pooling operation. The linear operation may also be referred to as linear mapping. The linear mapping needs to meet two conditions: homogeneity and additivity. If the linear mapping fails to meet either condition, the linear mapping is non-linear.

Homogeneity refers to f(ax)=af(x), and additivity refers to f(x+y)=f(x)+f(y), for example, f(x)=ax is linear. It should be noted that x, a, and f (x) are not necessarily scalars, and may be vectors or matrices, and form linear space of any dimension. If x and f(x) are n-dimensional vectors, when a is a constant, it is equivalent to satisfying homogeneity, and when a is a matrix, it is equivalent to satisfying additivity. In contrast, a function graph that is a straight line does not necessarily satisfy linear mapping, for example, f(x)=ax+b does not satisfy homogeneity or additivity, and therefore belongs to non-linear mapping.

In this embodiment of this application, a combination of a plurality of linear operations may be referred to as a linear operation. Linear operations included in the linear operation may also be referred to as sub-linear operations.

(7) BN: A parameter optimization difference between inputs at different levels is eliminated through small-batch normalization. A possibility of overfitting at a specific layer of a model is reduced, so that training may be performed more smoothly.

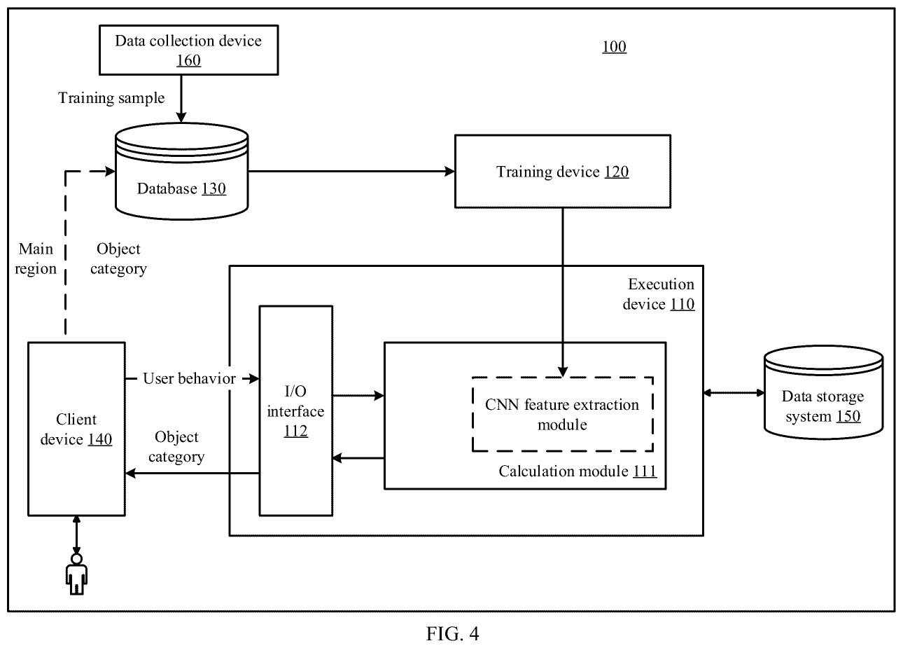

FIG. 4 is a schematic diagram of an architecture of a system according to an embodiment of this application. In FIG. 4, an input/output (input/output, I/O) interface 112 is configured for an execution device 110 to exchange data with an external device. A user may input data to the I/O interface 112 through a client device 140.

In a process in which the execution device 110 pre-processes the input data, or in a process in which a calculation module 111 of the execution device 110 performs related processing such as calculations (for example, implements a function of the neural network in this application), the execution device 110 may call data, code, and the like in a data storage system 150 for corresponding processing, or may store data, instructions, and the like obtained through the corresponding processing into the data storage system 150.

Finally, the I/O interface 112 returns a processing result to the client device 140, and provides the processing result to the user.

In an embodiment, the client device 140 may be, for example, a control unit in a self-driving system or a function algorithm module in a mobile phone terminal. For example, the function algorithm module may be configured to implement a related task.

It should be noted that a training device 120 may generate corresponding target models/rules (for example, the target neural network model in this embodiment) for different targets or different tasks based on different training data. The corresponding target models/rules may be used to implement the foregoing targets or complete the foregoing tasks, to provide a required result for the user.

In a case shown in FIG. 4, the user may manually input data and the user may input the data on an interface provided by the I/O interface 112. In another case, the client device 140 may automatically send input data to the I/O interface 112. If the client device 140 is required to obtain authorization from the user to automatically send the input data, the user may set corresponding permission on the client device 140. The user may view, on the client device 140, a result output by the execution device 110. In an embodiment, the result may be presented in a form of displaying, a sound, an action, or the like. The client device 140 may alternatively be used as a data collection end, to collect, as new sample data, input data input to the I/O interface 112 and an output result output from the I/O interface 112 that are shown in the figure. The new sample data is stored in a database 130. It is clear that the client device 140 may alternatively not perform collection. Instead, the I/O interface 112 directly stores, in the database 130 as new sample data, the input data input to the I/O interface 112 and the output result output from the I/O interface 112.

It should be noted that FIG. 4 is merely a schematic diagram of the architecture of the system according to an embodiment of this application. A location relationship between a device, a component, a module, and the like shown in the figure constitutes no limitation. For example, in FIG. 4, a data storage system 150 is an external memory relative to the execution device 110. In another case, the data storage system 150 may alternatively be disposed in the execution device 110.

The model training method provided in embodiments of this application is first described by using a model training phase as an example.

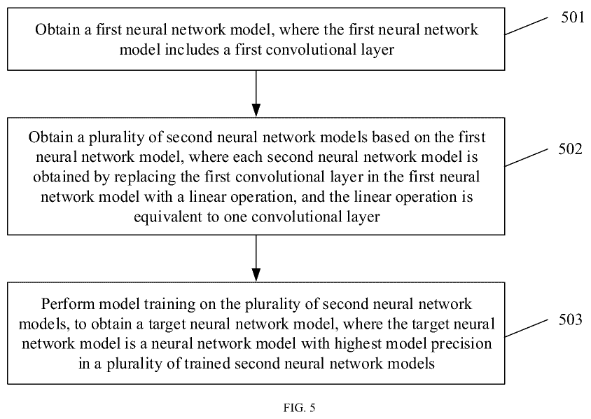

FIG. 5 is a schematic diagram of an embodiment of a model training method according to an embodiment of this application. As shown in FIG. 5, the model training method provided in this embodiment of this application includes the following operations.

501: Obtain a first neural network model, where the first neural network model includes a first convolutional layer.

In this embodiment of this application, a training device may obtain a to-be-trained first neural network model, and the first neural network model may be a to-be-trained model provided by a user.

In this embodiment of this application, the training device may replace some or all convolutional layers in the first neural network model with linear operations. A replaced convolutional layer object may be the first convolutional layer included in the first neural network model. In an embodiment, the first neural network model may include a plurality of convolutional layers, and the first convolutional layer is one of the plurality of convolutional layers. Replaced convolutional layer objects may be a plurality of convolutional layers included in the first neural network model, and the first convolutional layer is one of the plurality of convolutional layers.

In this embodiment of this application, the training device may select, from the first neural network model, a convolutional layer (including the first convolutional layer) that needs to be replaced.

In an implementation, a management personnel may specify a convolutional layer that is in the first neural network model and that needs to be replaced, or the training device determines, through searching based on a model structure, a convolutional layer that is in the first neural network model and that needs to be replaced. A subsequent embodiment will describe how the training device determines, through searching based on a model structure, a convolutional layer that needs to be replaced. Details are not described herein again.

502: Obtain a plurality of second neural network models based on the first neural network model, where each second neural network model is obtained by replacing the first convolutional layer in the first neural network model with the linear operation, and the linear operation is equivalent to one convolutional layer.

In this embodiment of this application, the training device may replace the first convolutional layer in the first neural network model with the linear operation, to obtain the second neural network model. In this way, the plurality of second neural network models are obtained. Each second neural network model is obtained by replacing the first convolutional layer in the first neural network model with the linear operation.

In this embodiment of this application, the linear operation is equivalent to one convolutional layer.

In this embodiment of this application, “equivalent” indicates a relationship between two operation units. In an embodiment, two operation units in different forms obtain same processing results when processing any same data. For the two operation units, one operation unit may be converted into an operation unit of another form through mathematical operation derivation. In this embodiment of this application, a sub-linear operation included in the linear operation may be converted into a form of a convolutional layer through mathematical operation derivation. The convolutional layer obtained through the conversion and the linear operation obtain same processing results when processing same data.

In this embodiment of this application, to enable the linear operation to be equivalent to one convolutional layer, a plurality of sub-linear operations included in the linear operation include at least one convolution operation. In an embodiment, the linear operation includes the plurality of sub-linear operations. The sub-linear operations herein may be basic linear operations instead of an operation formed by combining a plurality of basic linear operations. The linear operation herein refers to an operation formed by combining a plurality of basic linear operations. For example, an operation type of the sub-linear operation may be but is not limited to an addition operation, a null operation, an identity operation, a convolution operation, a batch normalization BN operation, or a pooling operation. Correspondingly, the linear operation may be a combination of sub-linear operations of at least one type of the addition operation, the null operation, the identity operation, the convolution operation, the batch normalization BN operation, and the pooling operation. It should be understood that the combination herein means that a quantity of the sub-linear operations is greater than or equal to 2, there is a connection relationship between the sub-linear operations, and there is no isolated sub-linear operation. That there is the connection relationship means that an output of one sub-linear operation is used as an input of another sub-linear operation (other than a sub-linear operation on an output side of the linear operation, where an output of the sub-linear operation is used as an output of the linear operation).

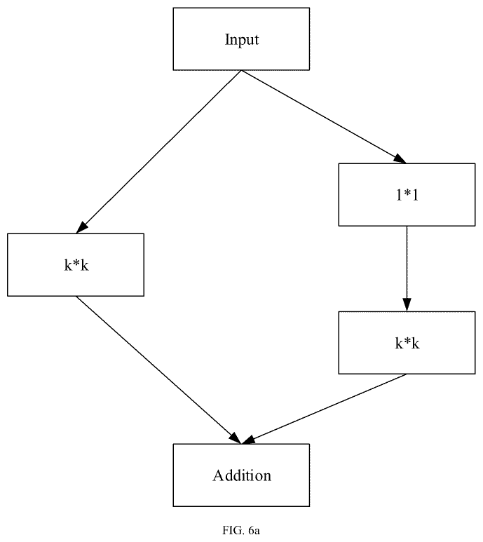

For example, with reference to FIG. 6a, FIG. 6b, and FIG. 6c, FIG. 6a, FIG. 6b, and FIG. 6c are schematic diagrams of several structures of the linear operation according to an embodiment of this application. A linear operation shown in FIG. 6a includes four sub-linear operations. The four sub-linear operations include a convolution operation 1 (a convolution size is k*k), a convolution operation 2 (a convolution size is 1*1), a convolution operation 3 (a convolution size is k*k), and an addition operation. The convolution operation 1 processes input data of a linear operation to obtain an output 1. The convolution operation 2 processes the input data of the linear operation to obtain an output 2. The convolution operation 3 processes the output 2 to obtain an output 3. The addition operation adds the output 1 and the output 3 to obtain an output of the linear operation.

A linear operation shown in FIG. 6b includes seven sub-linear operations. The seven sub-linear operations include a convolution operation 1 (a convolution size is k*k), a convolution operation 2 (a convolution size is 1*1), a convolution operation 3 (a convolution size is k*k), a convolution operation 4 (a convolution size is 1*1), a convolution operation 5 (a convolution size is k*k), a convolution operation 6 (a convolution size is 1*1), and an addition operation. The convolution operation 1 processes input data of the linear operation to obtain an output 1. The convolution operation 2 processes the input data of the linear operation to obtain an output 2. The convolution operation 3 processes the output 2 to obtain an output 3. The convolution operation 4 processes the input data of the linear operation to obtain an output 4. The convolution operation processes the output 4 to obtain an output 5. The convolution operation 6 processes the output to obtain an output 6. The addition operation adds the output 1, the output 3, and the output 6 to obtain an output of the linear operation.

A linear operation shown in FIG. 6c includes eight sub-linear operations. The eight sub-linear operations include a convolution operation 1 (a convolution size is k*k), a convolution operation 2 (a convolution size is 1*1), a convolution operation 3 (a convolution size is k*k), a convolution operation 4 (a convolution size is 1*1), a convolution operation 5 (a convolution size is 1*1), a convolution operation 6 (a convolution size is k*k), an addition operation 1, and an addition operation 2. The convolution operation 1 processes input data of the linear operation to obtain an output 1. The convolution operation 2 processes the input data of the linear operation to obtain an output 2. The convolution operation 3 processes the output 2 to obtain an output 3. The convolution operation 4 processes the output 2 to obtain an output 4. The convolution operation 5 processes the input data of the linear operation to obtain an output 5. The addition operation 1 adds the output 4 and the output 5 to obtain an output 6. The convolution operation 6 processes the output 6 to obtain an output 7. The addition operation 2 adds the output 1, the output 3, and the output 7, to obtain an output of the linear operation.

The following describes a linear operation for replacing the first convolutional layer.

In this embodiment of this application, to enable the linear operation to be equivalent to one convolutional layer, the plurality of sub-linear operations included in the linear operation include at least one convolution operation. In a subsequent model inference process, to avoid reducing a speed of an inference phase or increasing resource consumption of the inference phase, a linear operation is not used for model inference, but a convolutional layer (which may be referred to as a second convolutional layer in a subsequent embodiment) equivalent to the linear operation is used for the model inference. It is necessary to ensure that a receptive field of the convolutional layer equivalent to the linear operation is less than or equal to a receptive field of the first convolutional layer.

The following describes how to ensure that an equivalent receptive field of the linear operation is less than or equal to the receptive field of the first convolutional layer.

In this embodiment of this application, to ensure that the equivalent receptive field of the linear operation is less than or equal to the receptive field of the first convolutional layer, the equivalent receptive field of each operation branch in the linear operation is required to be less than or equal to the receptive field of the first convolutional layer. The following describes in detail the receptive field of each operation branch in the linear operation.

First, the concept of an operation branch is described as follows.

An input and an output of the linear operation are two endpoints, and a data path between the two endpoints may be an operation branch. A start point of the operation branch is the input of the linear operation, and an end point of the operation branch is the output of the linear operation. In an implementation, the linear operation may include the plurality of parallel operation branches. Each operation branch is used to process the input data of the linear operation. In other words, a start point of each operation branch is an input of the linear operation. In this way, an input of a sub-linear operation that is in each operation branch and that is closest to the input of the linear operation is input data of the linear operation. In other words, each operation branch is used to process the input data of the linear operation, and each operation branch includes at least one serial sub-linear operation. In other words, the linear operation may be represented as a computational graph. In the computational graph, input sources and flow directions of output data of the sub-linear operations are defined. In the computational graph, any path from the input to the output may be defined as an operation branch of the linear operation.

For example, with reference to FIG. 6a, the linear operation shown in FIG. 6a may include two operation branches (represented as an operation branch 1 and an operation branch 2 in this embodiment). The operation branch 1 includes the convolution operation 1 and the addition operation. The operation branch 2 includes the convolution operation 2, the convolution operation 3, and the addition operation. Both the operation branch 1 and the operation branch 2 are used to process the input data of the linear operation. A data flow direction of the operation branch 1 is from the convolution operation 1 to the addition operation. In other words, the input data of the linear operation is sequentially processed through the convolution operation 1 and the addition operation. A data flow direction of the operation branch 2 is from the convolution operation 2 and the convolution operation 3 to the addition operation. In other words, the input data of the linear operation is sequentially processed through the convolution operation 2, the convolution operation 3, and the addition operation.

For example, with reference to FIG. 6b, the linear operation shown in FIG. 6b may include three operation branches (represented as an operation branch 1, an operation branch 2, and an operation branch 3 in this embodiment). The operation branch 1 includes the convolution operation 1 and the addition operation. The operation branch 2 includes the convolution operation 2, the convolution operation 3, and the addition operation. The operation branch 3 includes the convolution operation 4, the convolution operation 5, the convolution operation 6, and the addition operation. The operation branch 1, the operation branch 2, and the operation branch 3 are all used to process the input data of the linear operation. A data flow direction of the operation branch 1 is from the convolution operation 1 to the addition operation. In other words, the input data of the linear operation is sequentially processed through the convolution operation 1 and the addition operation. A data flow direction of the operation branch 2 is from the convolution operation 2 and the convolution operation 3 to the addition operation. In other words, the input data of the linear operation is sequentially processed through the convolution operation 2, the convolution operation 3, and the addition operation. A data flow direction of the operation branch 3 is from the convolution operation 4, the convolution operation 5, and the convolution operation 6 to the addition operation. In other words, the input data of the linear operation is sequentially processed through the convolution operation 4, the convolution operation 5, the convolution operation 6, and the addition operation.

For example, with reference to FIG. 6c, the linear operation shown in FIG. 6c may include four operation branches (represented as an operation branch 1, an operation branch 2, an operation branch 3, and an operation branch 4 in this embodiment). The operation branch 1 includes the convolution operation 1 and the addition operation 2. The operation branch 2 includes the convolution operation 2, the convolution operation 3, and the addition operation 2. The operation branch 3 includes the convolution operation 2, the convolution operation 4, the addition operation 1, the convolution operation 6, and the addition operation 2. The operation branch 4 includes the convolution operation 5, the addition operation 1, the convolution operation 6, and the addition operation 2. The operation branch 1, the operation branch 2, the operation branch 3, and the operation branch 4 are all used to process the input data of the linear operation. A data flow direction of the operation branch 1 is from the convolution operation 1 to the addition operation 2. In other words, the input data of the linear operation is sequentially processed through the convolution operation 1 and the addition operation 2. A data flow direction of the operation branch 2 is from the convolution operation 2 and the convolution operation 3 to the addition operation 2. In other words, the input data of the linear operation is sequentially processed through the convolution operation 2, the convolution operation 3, and the addition operation 2. A data flow direction of the operation branch 3 is from the convolution operation 2, the convolution operation 4, the addition operation 1, and the convolution operation 6 to the addition operation 2. In other words, the input data of the linear operation is sequentially processed through the convolution operation 2, the convolution operation 4, the addition operation 1, the convolution operation 6, and the addition operation 2. A data flow direction of the operation branch 4 is from the convolution operation 5, the addition operation 1, and the convolution operation 6 to the addition operation 2. In other words, the input data of the linear operation is sequentially processed through the convolution operation 5, the addition operation 1, the convolution operation 6, and the addition operation 2.

The following describes the equivalent receptive field of each operation branch in the linear operation.

For a single sub-linear operation, for example, a receptive field of k*k convolution or pooling is k, and receptive fields of an addition operation and a BN operation are 1. That an equivalent receptive field of an operation branch is k is defined as: each output of the operation branch is affected by k*k inputs. A method for calculating a receptive field of an operation branch is as follows: It is assumed that the operation branch includes N sub-linear operations, and a receptive field of each of the N sub-linear operations is ki (i is a positive integer less than or equal to N). An equivalent receptive field of the N sub-linear operations is k1+k2+ . . . +kN−(N−1). For example, an equivalent receptive field of two 3*3 convolution operations is 3+3−1=5.

For example, an equivalent receptive field of the operation branch 1 in the linear operation in FIG. 6a is k (a calculation method is k+1−1=k).

For example, an equivalent receptive field of the operation branch 2 in the linear operation in FIG. 6a is k (a calculation method is 1+k+1−2=k).

For example, an equivalent receptive field of the operation branch 1 in the linear operation in FIG. 6b is k (a calculation method is k+1−1=k).

For example, an equivalent receptive field of the operation branch 2 in the linear operation in FIG. 6b is k (a calculation method is 1+k+1−2=k).

For example, the equivalent receptive field of the operation branch 3 in the linear operation in FIG. 6b is k (the calculation method is 1+k+1+1−3=k).

For example, an equivalent receptive field of an operation branch 1 in the linear operation in FIG. 6c is k (a calculation method is k+1−1=k).

For example, an equivalent receptive field of the operation branch 2 in the linear operation in FIG. 6c is k (a calculation method is 1+k+1−2=k).

For example, an equivalent receptive field of the operation branch 3 in the linear operation in FIG. 6c is k (a calculation method is 1+1+1+k+1−4=k).

For example, an equivalent receptive field of the operation branch 4 in the linear operation in FIG. 6c is k (a calculation method is 1+1+k+1−2=k).

In this embodiment of this application, the receptive field of the convolutional layer equivalent to the linear operation is the same as the receptive field of the linear operation, and the receptive field of the linear operation is equal to a largest receptive field of the operation branches. For example, if the receptive fields of the operation branches included in the linear operation are 3, 5, 5, 5, and 7, the receptive field of the linear operation is equal to 7.

To enable the receptive field of the convolutional layer equivalent to the linear operation to be less than or equal to the receptive field of the first convolutional layer, it is required to ensure that the receptive field of the linear operation is less than or equal to the equivalent receptive field of the first convolution kernel. To be specific, the equivalent receptive field of each operation branch in the linear operation is less than or equal to the receptive field of the first convolutional layer.

In an implementation, the linear operation may include only one operation branch, and the operation branch is configured to process the input data of the linear operation. The operation branch includes at least one serial sub-linear operation. In this case, an equivalent receptive field of the only operation branch included in the linear operation is less than or equal to the receptive field of the first convolutional layer.

The following describes a concept of a receptive field of a convolutional layer.

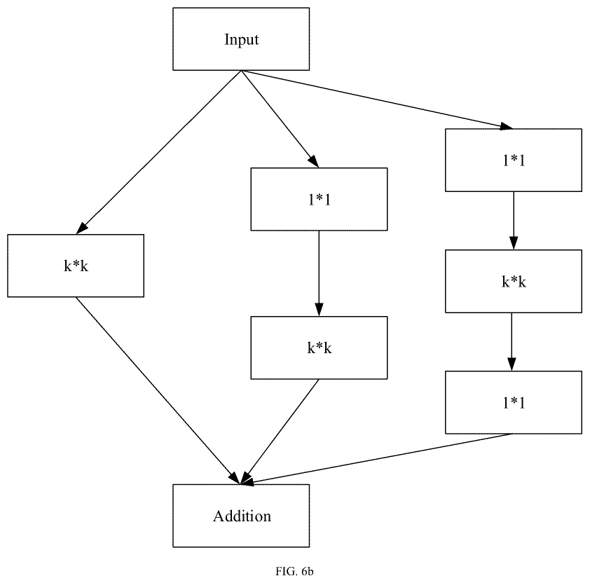

For example, an object to be processed is an image. The receptive field is a receptive region (a receptive range) of a feature on an input image at a convolutional layer. If a pixel in the receptive range changes, a value of the feature changes accordingly. As shown in FIG. 7, a convolution kernel slides on an input image, and extracted features constitute a convolutional layer 101. Similarly, the convolution kernel slides at the convolutional layer 101, and extracted features constitute a convolutional layer 102. In this case, each feature of the convolutional layer 101 is extracted based on a pixel that is of an input image and that is within a size of a convolution slice of the convolution kernel sliding on the input image. The size is a receptive field of the convolutional layer 101. Therefore, the receptive field of the convolutional layer 101 is shown in FIG. 7.

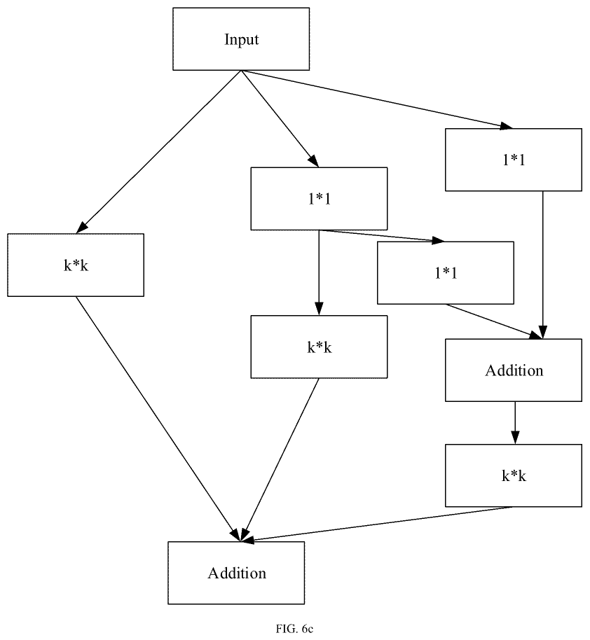

Correspondingly, a range in which features of the convolutional layer 102 are mapped onto the input image (in other words, a pixel within a specific range on the input image) is a receptive field of the convolutional layer 102. As shown in FIG. 8, each feature in the convolutional layer 102 is extracted based on a pixel that is of the input image and that is within a size of a convolution slice of the convolution kernel sliding on the convolutional layer 101. Each feature of the convolutional layer 101 is extracted based on a pixel that is of the input image and that is within a range of the convolution slice of the convolution kernel sliding on the input image. Therefore, the receptive field of the convolutional layer 102 is larger than the receptive field of the convolutional layer 101.

In an implementation, the equivalent receptive field of the at least one of the plurality of parallel operation branches is equal to the receptive field of the first convolutional layer. In this case, the receptive field of the linear operation is equal to the receptive field of the first convolutional layer. In this way, the receptive field of the convolutional layer (which is subsequently described as a second convolutional layer) equivalent to the linear operation is equal to the receptive field of the first convolutional layer. The second convolutional layer may be used in a subsequent model inference process. Because the receptive field of the second convolutional layer is the same as the receptive field of the first convolutional layer, on a premise that a size specification of a model used for the inference process is the same as a size specification of a neural network model in which a convolutional layer is not replaced, that is, the speed and the resource consumption of the inference phase remain unchanged, a quantity of training parameters is increased and precision of the model is improved, compared with a case in which the receptive field of the second convolutional layer is less than the receptive field of the first convolutional layer.

The linear operations for replacing the convolutional layer are described above. In this embodiment of this application, the training device may obtain a plurality of linear operations, replace a first convolutional layer in a first neural network model with one of the plurality of linear operations (or replace a plurality of convolutional layers (including the first convolutional layer) in the first neural network model with one of the plurality of linear operations), and the like, to obtain a plurality of second neural network models. Each second neural network model is obtained by replacing the first convolutional layer in the first neural network model with the linear operation.

The following describes how the plurality of linear operations are obtained.

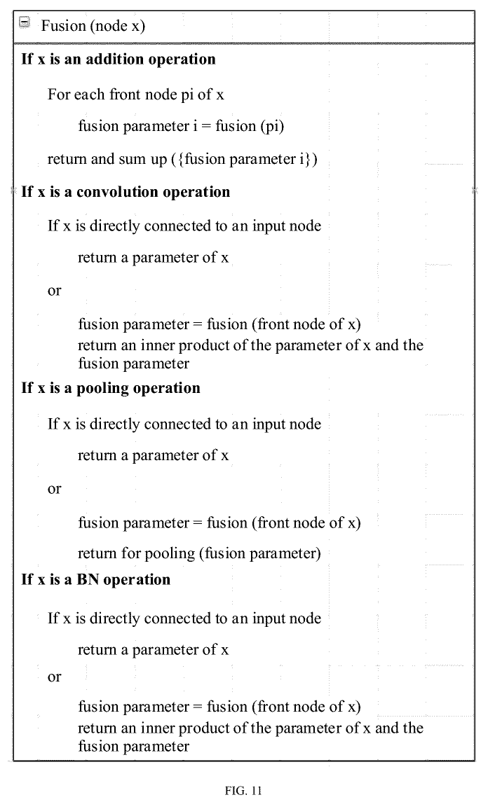

In this embodiment of this application, a specific sampling-based search algorithm, such as reinforcement learning or a genetic algorithm, may be selected, and search space including a linear operation is encoded. For example, in a feasible encoding mode, optional sub-linear operations are first sequentially encoded. For example, a null operation, an identity operation, a 1*1 convolution, a 3*3 convolution, BN, and 3*3 pooling are respectively encoded as 0, 1, 2, 3, 4, and 5. Then, an adjacency matrix M is used to represent a computational graph of a group of linear operations. For a computational graph of N nodes (other than an input node), the adjacency matrix M is an N*(N+1) matrix, and a row number of the matrix is from 1 to N, and a column number is from 0 to N. A value M[i, j] of the i^{th} row and the j^{th} column of the matrix indicates that an operation corresponding to M[i, j] is performed on an output of the j^{th} node and a result is added at the i^{th} node. If M[i, j]=0, it indicates that the j^{th} node and the i^{th} node are not directly connected by using an operation. Based on the encoding scheme, code corresponding to the linear operation shown in FIG. 11 may be shown in Table 1 (it is assumed that k=3).

TABLE 1

| | | | | | | | | |
|---|---|---|---|---|---|---|---|---|
| 3 | 0 | 0 | 0 | 0 | 0 | 0 | 0 | 0 |
| 2 | 0 | 0 | 0 | 0 | 0 | 0 | 0 | 0 |
| 0 | 0 | 3 | 0 | 0 | 0 | 0 | 0 | 0 |
| 2 | 0 | 0 | 0 | 0 | 0 | 0 | 0 | 0 |
| 0 | 0 | 2 | 0 | 0 | 0 | 0 | 0 | 0 |
| 0 | 0 | 0 | 0 | 1 | 1 | 0 | 0 | 0 |
| 0 | 0 | 0 | 0 | 0 | 0 | 3 | 0 | 0 |
| 0 | 1 | 0 | 1 | 0 | 0 | 0 | 1 | 0 |

Then, the code of the linear operation may be sampled based on the search algorithm. The first convolution in the first neural network model is replaced with a linear operation corresponding to the code of the linear operation.

In an implementation, only one second neural network model may be obtained. In other words, one target linear operation is determined, and the first convolutional layer in the first neural network model is replaced with the determined target linear operation, to obtain the second neural network model. In an embodiment, the training device may obtain the second neural network model based on the first neural network model. The second neural network model is obtained by replacing the first convolutional layer in the first neural network model with the target linear operation. The target linear operation includes a plurality of sub-linear operations. The target linear operation is equivalent to one convolutional layer. The target linear operation includes M operation branches. An input of each operation branch is an input of the target linear operation. The plurality of sub-linear operations meet at least one of the following conditions:
the plurality of sub-linear operations includes at least three operation types, M is not 3, and a quantity of sub-linear operations included in at least one of the M operation branches is not equal to 2, where M is a positive integer, or a quantity of sub-linear operations that are in at least one of the M operation branches and that have an operation type of convolution operations is not 1.

503: Perform model training on the plurality of second neural network models, to obtain a target neural network model, where the target neural network model is a neural network model with highest model precision in a plurality of trained second neural network models.

In this embodiment of this application, the training device may perform model training on the obtained plurality of second neural network models, to obtain the plurality of trained second neural network models, and determine the target neural network model from the plurality of trained second neural network models. The target neural network model is the neural network model with highest model precision in the plurality of second neural network models.

It should be understood that the action of obtaining the plurality of second neural networks in operation 502 is not necessarily executed after the action of performing model training on the plurality of second neural network models in operation 503 is executed. For example, after obtaining one second neural network model, the training device may train the second neural network model. After the training is completed, the training device obtains a next second neural network model, and the like. In this way, the training device may obtain the plurality of second neural network models, and train the plurality of second neural network models.

The quantity of the second neural network models may be pre-specified by the management personnel, or may be a quantity of second neural network models that have been trained when a search resource limit is reached in a process of training the second neural network model by the training device.

In this embodiment of this application, when the second neural network models are trained, model precisions (or referred to as verification precisions) of the trained second neural network models may be obtained. A second neural network model with highest model precision may be selected from the plurality of trained second neural network models based on the model precision of the trained second neural network models.

For example, the second neural network model with the highest model precision is the target neural network model. A second neural network model corresponding to the target neural network model is obtained by replacing the first convolutional layer in the first neural network model with the target linear operation. The neural network model with the highest precision includes a trained target linear operation.

Compared with the first convolutional layer, the target linear operation includes a plurality of sub-linear operations. If the target neural network model is directly used for the model inference, the model inference speed is reduced, and the resource consumption required for the model inference is increased. Therefore, in this embodiment, the second convolutional layer equivalent to the trained target linear operation may be obtained. The trained target linear operation in the target neural network model is replaced with the second convolutional layer, to obtain the third neural network model. The third neural network model may be used for the model inference.

It should be understood that, in this embodiment of this application, a training device may complete operations of obtaining the second convolutional layer equivalent to the trained target linear operation, and replacing the trained target linear operation in the target neural network model with the second convolutional layer to obtain the third neural network model. After training is completed, the training device may directly feed back the third neural network model. In an embodiment, the training device may send the third neural network model to a terminal device or a server. In this way, the terminal device or the server may perform model inference based on the third neural network model. Alternatively, before performing the model inference, the terminal device or the server obtains the second convolutional layer equivalent to the trained target linear operation, and replaces the trained target linear operation in the target neural network model with the second convolutional layer, to execute an action of obtaining the third neural network model.

The following describes how to obtain the second convolutional layer equivalent to the trained target linear operation.

In this embodiment of this application, based on a data processing sequence of a plurality of sub-linear operations included in the trained target linear operation, each sub-linear operation may be fused into an adjacent sub-linear operation that follows the sub-linear operation in the sequence, until fusion of a last sub-linear operation in the sequence is completed, to obtain the second convolutional layer equivalent to the target linear operation.

Each sub-linear operation may be fused to an adjacent sub-linear operation that follows the sub-linear operation in the sequence, until the fusion of the last sub-linear operation (the sub-linear operation closest to an output) is completed.

In this embodiment of this application, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

In an embodiment, the first sub-linear operation and the second sub-linear operation are any adjacent sub-linear operations in the trained target linear operation. The second sub-linear operation is a sub-linear operation that follows the first sub-linear operation in the sequence. The first sub-linear operation includes a first operation parameter. The first sub-linear operation is used to perform, based on the first operation parameter, processing corresponding to an operation type of the first sub-linear operation on input data of the first sub-linear operation. The second sub-linear operation includes a second operation parameter. The second sub-linear operation is used to perform, based on the second operation parameter, processing corresponding to an operation type of the second sub-linear operation on input data of the second sub-linear operation. In this way, a fusion parameter of the first sub-linear operation may be obtained. If the input data of the first sub-linear operation is input data of the trained target linear operation, the fusion parameter of the first sub-linear operation is the first operation parameter. A fusion parameter of the second sub-linear operation is obtained based on the fusion parameter of the first sub-linear operation, the second operation parameter, and the operation type of the second sub-linear operation. If the second sub-linear operation is the last sub-linear operation in the sequence, the fusion parameter of the second sub-linear operation is used as an operation parameter of the second convolutional layer.

In an embodiment, the operation type of the sub-linear operation in the linear operation includes at least one of the following: an addition operation, a null operation, an identity operation, a convolution operation, a batch normalization BN operation, or a pooling operation. Both the convolution operation and the BN operation include trainable operation parameters. For a representation manner of an adjacency matrix, a null operation (0) is required, and this is equivalent to absence of operations from the node i to the node j.

In this embodiment of this application, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

FIG. 11 shows a schematic diagram of a specific fusion policy. In FIG. 11, an example in which operation types of the second sub-linear operation are the addition operation (described as an addition operation in FIG. 11), the convolution operation, the pooling operation, and the BN operation is used for description.

For a linear operation of a trained target neural network, a fusion parameter=fusion (an output node). A fusion process is performed on each linear operation in a model, and a fully fused model is ultimately obtained. A structure of the model is the same as a structure of the original model. Therefore, a speed and resource consumption in an inference phase remain unchanged. In addition, the model before fusion and the model obtained through fusion are mathematically equivalent. Therefore, precision of the model obtained through fusion is the same as precision of the model before fusion.

The following describes the model training method in this embodiment of this application with reference to a specific embodiment in which an example in which the first neural network model is ResNet18 is used.

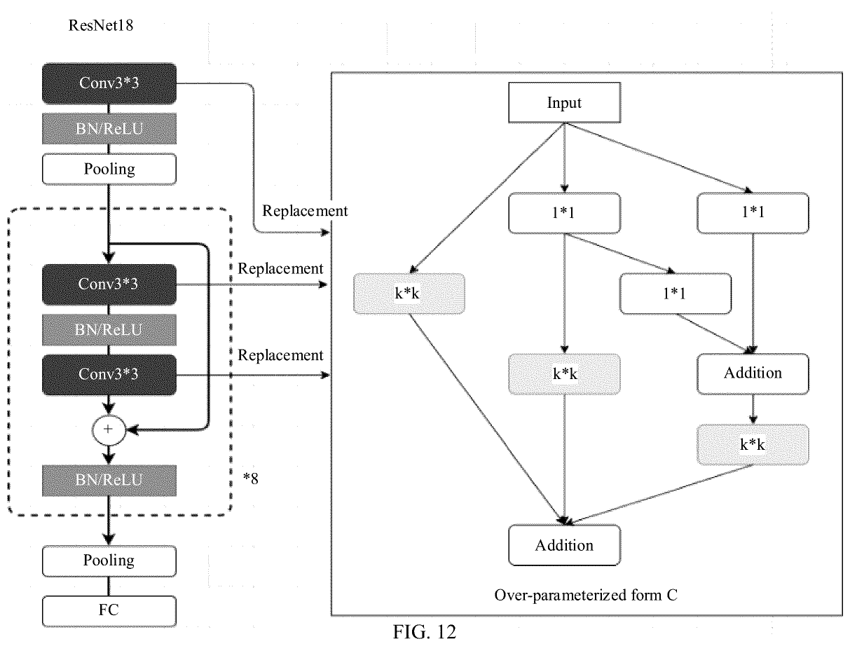

As shown in FIG. 12, a convolutional layer in the first neural network model is replaced with a linear operation. Herein, some convolutional layers may be selected to be replaced, or all convolutional layers are replaced. Forms of linear operations for replacing different convolutional layers may be different. Herein, only an example in which linear operations are in an over-parameterized form C shown in FIG. 12 is used. After replacement is completed, a second neural network model obtained through replacement is trained based on a training process of the original model, to obtain a trained model.

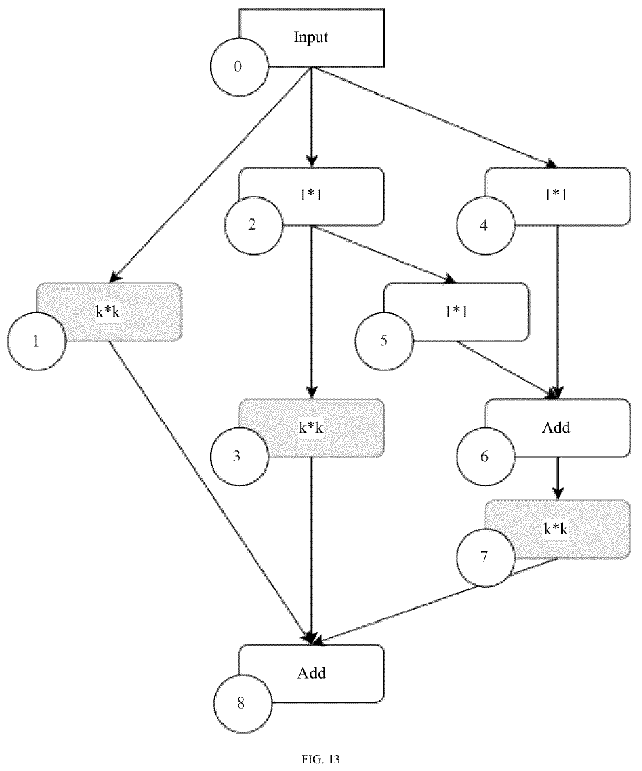

After the trained second neural network model is obtained, parameter fusion needs to be performed on each linear operation. As shown in FIG. 13 (in FIG. 13, sub-linear operations are separately represented as a node 1 to a node 8), using the over-parameterized form C as an example, a specific fusion process may be as follows.

For the node 1, the node 2, and the node 4, the node 1, the node 2, and the node 4 are all used to process an input of a linear operation (that is, nodes directly connected to an input of a node 0). Therefore, a fusion parameter of the node 1 is an operation parameter of the node 1, a fusion parameter of the node 2 is an operation parameter of the node 2, and a fusion parameter of the node 4 is an operation parameter of the node 4.

For the node 5, the node 5 is used to perform processing (the convolution operation) corresponding to an operation type of the node 5 on an output of the node 2 based on the operation parameter of the node 5. Therefore, a fusion parameter of the node 5 is an inner product of the fusion parameter of the node 2 and an operation parameter of the node 5.

For the node 6, the node 6 is used to perform processing (the addition operation) corresponding to an operation type of the node 6 on an output of the node 5 and an output of the node 4. Therefore, a fusion parameter of the node 6 is a sum of the fusion parameter of the node 5 and the operation parameter of the node 4.

For the node 3, the node 3 is used to perform processing (the convolution operation) corresponding to an operation type of the node 3 on the output of the node 2 based on an operation parameter of the node 3. Therefore, a fusion parameter of the node 3 is an inner product of the fusion parameter of the node 2 and an operation parameter of the node 3.

For the node 7, the node 7 is used to perform processing (the convolution operation) corresponding to an operation type of the node 7 on an output of the node 6 based on an operation parameter of the node 7. Therefore, a fusion parameter of the node 7 is an inner product of the fusion parameter of the node 6 and an operation parameter of the node 7.

For the node 8, the node 8 is used to perform processing (the addition operation) corresponding to an operation type of the node 8 on an output of the node 1, an output of the node 3, and an output of the node 7. Therefore, a fusion parameter of the node 8 is a sum of a fusion parameter of the node 1, the fusion parameter of the node 3, and the operation parameter of the node 7.

In this way, the fusion parameter of the node 8 may be used as an operation parameter of the second convolutional layer, and the second convolutional layer may perform the convolution operation on the input data based on the operation parameter of the second convolutional layer.

The following describes a fusion process of the linear operations in FIG. 13 from a perspective of pseudo-code.
Fusion parameter=fusion (node 8): Perform addition, where front nodes are 1, 3, and 7
Fusion parameter of the node 1=fusion (node 1): Perform convolution, directly connect to an input, and return a parameter
Fusion parameter of the node 3=fusion (node 3): Perform convolution, where a front node is 2
Fusion parameter of the node 2=fusion (node 2): Perform convolution, directly connect to an input, and return a parameter return an inner product of the parameter of the node 3 and the fusion parameter of the node 2
Fusion parameter of the node 7=fusion (node 7): Perform convolution, where a front node is 6
Fusion parameter of the node 6=fusion (node 6): Perform addition, where front nodes are 5 and 4
Fusion parameter of the node 5=fusion (node 5): Perform convolution, where a front node is 2
Fusion parameter of the node 2=fusion (node 2): Perform convolution, directly connect to an input, and return a parameter return an inner product of the parameter of the node 5 and the fusion parameter of the node 2
Fusion parameter of the node 4=fusion (node 4): Perform convolution, directly connect to an input, and return a parameter
return and sum up ({the fusion parameter of the node 5, the fusion parameter of the node 4})
return an inner product of the parameter of the node 7 and the fusion parameter of the node 6
return and sum up ({the fusion parameter of the node 1, the fusion parameter of the node 3, the fusion parameter of the node 7})

For each linear operation, fusion of the sub-linear operations is performed based on the foregoing process, and a fully fused model is ultimately obtained. The fused model has the same structure as the original ResNet-18 model.

In this embodiment of this application, to enable a model used for the inference to have a same specification as the first neural network model before the training, a size of the second convolutional layer is required to be the same as a size of the first convolutional layer.

The following first describes a concept of a size of a convolutional layer.

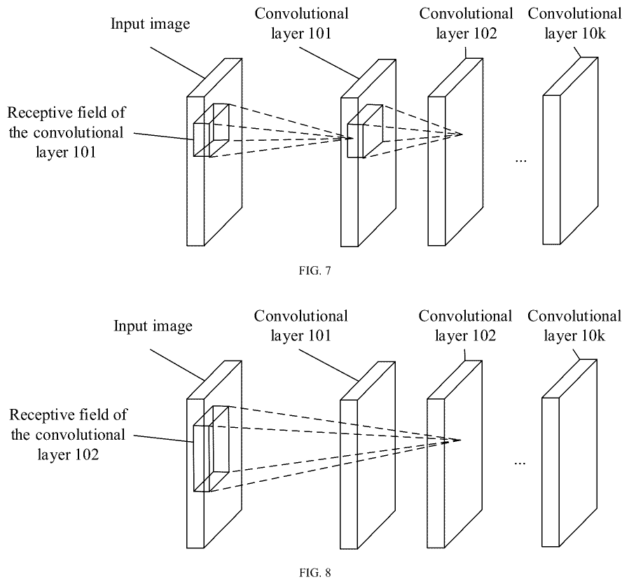

A size of the convolutional layer may indicate a quantity of features included in the convolutional layer. For example, the following describes the size of the convolutional layer with reference to the convolutional layer and the convolution kernel. As shown in FIG. 9, a size of a convolutional layer 101 is X*Y*N1. In other words, the convolutional layer 101 includes X*Y*N1 features. N1 represents a quantity of channels, one channel is one feature dimension, and X*Y represents a quantity of features included in each channel, where X, Y, and N1 are all positive integers greater than 0. A convolution kernel 1011 is one of convolution kernels used at the convolutional layer 101. A convolutional layer 102 includes N2 channels. Therefore, the convolutional layer 101 uses N2 convolution kernels in total. Sizes and model parameters of the N2 convolution kernels may be the same or different. The convolution kernel 1011 is used as an example, and a size of the convolution kernel 1011 is X1*X1*N1. In other words, the convolution kernel 1011 includes X1*X1*N1 model parameters. When the convolution kernel 1011 slides at the convolutional layer 101 and slides to a specific location at the convolutional layer 101, the model parameters of the convolution kernel 1011 are multiplied by features at a corresponding location of the convolutional layer 101. Product results of the model parameters of the convolution kernel 1011 and the features at the corresponding location of the convolutional layer 101 are combined, to obtain one feature of the channel of the convolutional layer 102. The product results of the features of the convolutional layer 101 and the model parameters of the convolution kernel 1011 may be directly used as features of the convolutional layer 102. Alternatively, after sliding of the features of the convolutional layer 101 and the convolution kernel 1011 is completed at the convolutional layer 101, and all product results are output, all the product results may be normalized, and a normalized product result is used as a feature of the convolutional layer 102. It is vividly expressed that the convolution kernel 1011 performs convolution at the convolutional layer 101 in a sliding manner, and a convolution result is used as a channel of the convolutional layer 102. Each convolution kernel used at the convolutional layer 101 corresponds to one channel of the convolutional layer 102. Therefore, a quantity of channels of the convolutional layer 102 is equal to a quantity of the convolution kernels used at the convolutional layer 101. The model parameter of each convolution kernel is designed to reflect a characteristic of a feature that the convolution kernel expects to extract from the convolutional layer. Features of N2 channels are extracted from the convolutional layer 101 by using N2 convolution kernels.

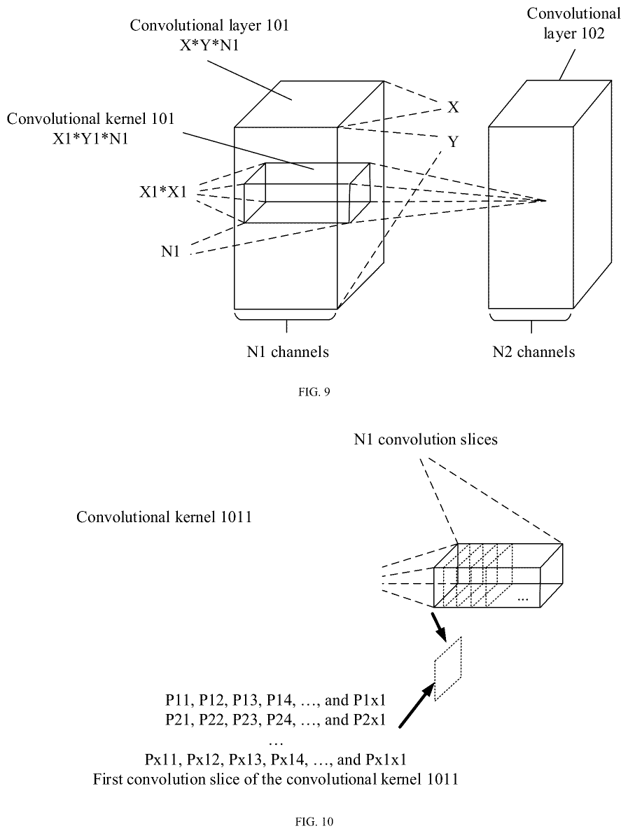

As shown in FIG. 10, the convolution kernel 1011 is split. The convolution kernel 1011 includes N1 convolution slices, and each convolution slice includes X1*X1 model parameters (from P11 to P*1*1). Each model parameter corresponds to one convolution point. A model parameter corresponding to one convolution point is multiplied by a feature at a location that is corresponding to the convolution point and that is located at a convolutional layer, to obtain a convolution result of the convolution point. A sum of convolution results of convolution points of one convolution kernel is a convolution result of the convolution kernel.

In an implementation, if the receptive field of the target linear operation is equal to the receptive field of the first convolutional layer, the size of the second convolutional layer is the same as the size of the first convolutional layer.

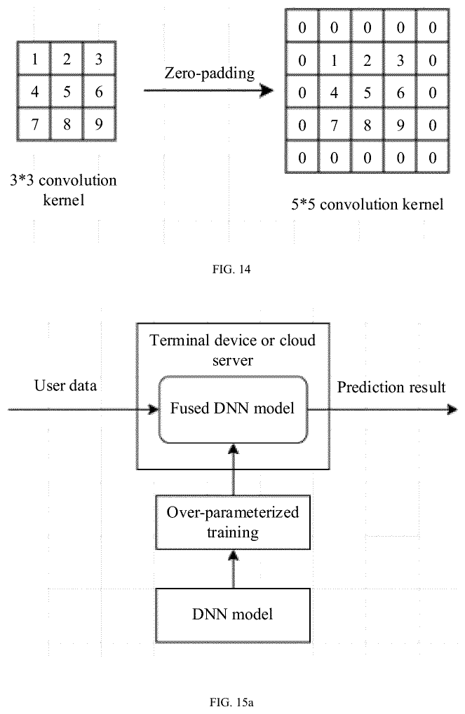

In an implementation, if the receptive field of the target linear operation is less than the receptive field of the first convolutional layer, a size of an equivalent convolutional layer obtained through calculation is less than the size of the first convolutional layer. In this case, a zero-padding operation may be performed on the equivalent convolutional layer obtained through calculation, to obtain the second convolutional layer with a size the same as the size of the first convolutional layer. For details, with reference to FIG. 14, FIG. 14 is a schematic diagram of a zero-padding operation according to an embodiment of this application.

In this embodiment of this application, a convolutional layer in a to-be-trained neural network is replaced with a linear operation that may be equivalent to a convolutional layer. A manner with highest precision is selected from a plurality of replacement manners, to improve precision of a trained model. Table 2 shows precisions of network models obtained in different replacement manners (which are represented as over-parameterized forms in Table 2). In an embodiment, in this task, a lower loss indicates a stronger model fitting capability and higher model precision. As shown in Table 2, for the two model structures, a loss after over-parameterized training is lower than a baseline of the original model structure. In addition, different model structures have different optimal over-parameterized forms.

TABLE 2

| | | Over- | Over- | Over- |
|---|---|---|---|---|
| | | parameterized | parameterized | parameterized |
| Loss | Baseline | form A | form B | form C |
| Model | 1.625 | 1.581 | 1.582 | 1.598 |
| structure 1 | | | | |
| Model | 1.589 | 1.574 | 1.564 | 1.563 |
| structure 2 | | | | |

An embodiment of this application provides a model training method. The method includes: obtaining a first neural network model, where the first neural network model includes a first convolutional layer; obtaining a plurality of second neural network models based on the first neural network model, where each second neural network model is obtained by replacing the first convolutional layer in the first neural network model with a linear operation, and the linear operation is equivalent to a convolutional layer; and performing model training on the plurality of second neural network models to obtain a target neural network model, where the target neural network model is a neural network model with highest model precision in a plurality of trained second neural network models. In the foregoing manner, a convolutional layer in a to-be-trained neural network is replaced with a linear operation that may be equivalent to a convolutional layer. A manner with highest precision is selected from a plurality of replacement manners, to improve precision of a trained model.

The following describes several application scenarios of embodiments of this application from a perspective of product application.

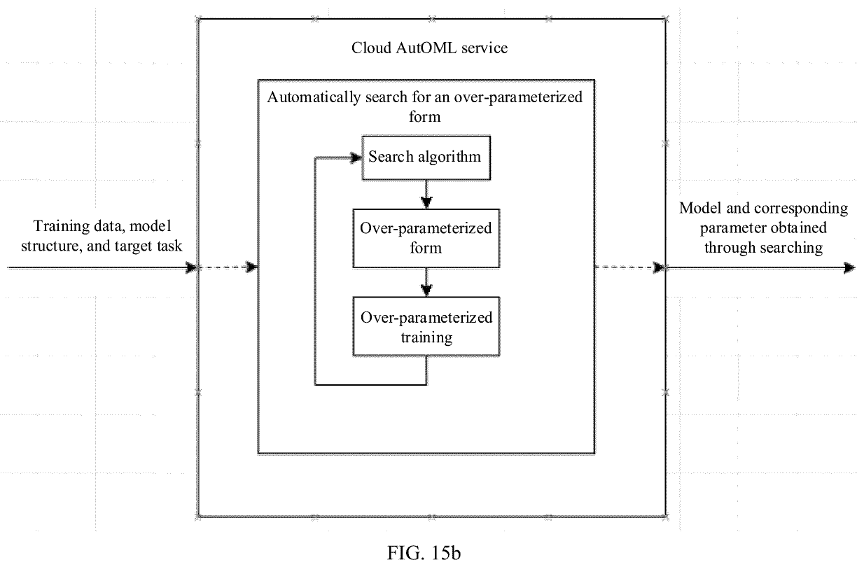

A typical application scenario of embodiments of this application may include a neural network model on a terminal device. In an embodiment, a model obtained through training using the training method provided in embodiments of this application may be deployed on the terminal device (for example, a smartphone) or a cloud server, to provide an inference capability. In an embodiment, as shown in FIG. 15a, model training according to the training method provided in embodiments of this application may be performed on the first neural network model (described as a DNN model in FIG. 15a). An over-parameterized model obtained through fusion is deployed on the terminal device or the cloud server, to perform inference on user data.

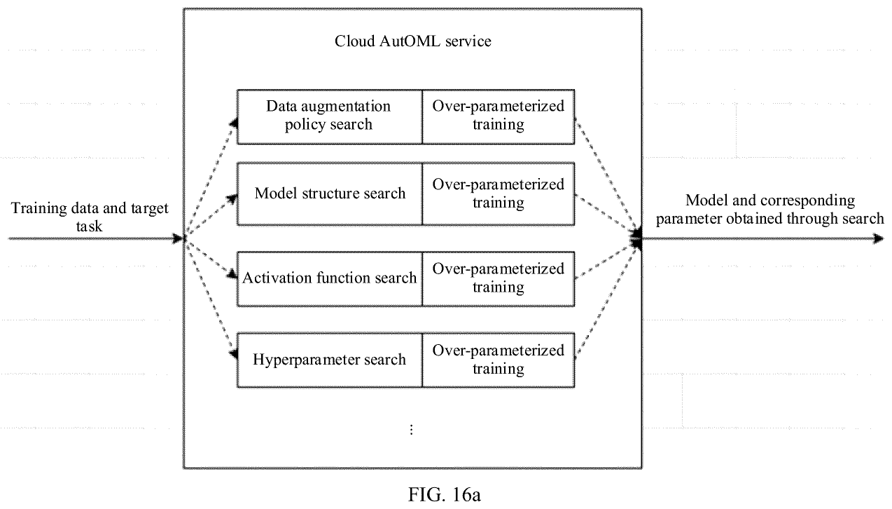

The training method provided in embodiments of this application may also be applied to a cloud AutoML service, to further improve model effect, in combination with other AutoML technologies such as data augmentation policy search, model structure search, activation function search, and hyperparameter search. In an embodiment, as shown in FIG. 15b and FIG. 16a, a user provides training data and a model structure, and specifies a target task. The cloud AutoML service automatically performs over-parameterized search, to ultimately output a model and a corresponding parameter obtained through the search. Alternatively, over-parameterized training may be combined with other AutoML technologies, such as data augmentation policy search, model structure search, activation function search, and hyperparameter search, to further improve model effect.

FIG. 16b is a schematic flowchart of a model training method according to an embodiment of this application. As shown in FIG. 16b, the model training method provided in this embodiment of this application includes the following operations.

1601: Obtain a first neural network model, where the first neural network model includes a first convolutional layer, and the first neural network model is used to implement a target task.

For descriptions of operation 1601, refer to the descriptions of operation 501. Details are not described herein again.

1602: Determine, based on at least one piece of the following information, a target linear operation for replacing the first convolutional layer, where the information includes a network structure of the first neural network model, the target task, and a location of the first convolutional layer in the first neural network model, and the target linear operation is equivalent to one convolutional layer.

Different linear operations may be selected for neural network models of different network structures, neural network models that implement different target tasks, and convolutional layers at different locations in the neural network models, so that model precision of a trained neural network model in which the convolutional layer is replaced is high.

The target linear operation may be determined based on the network structure of the first neural network model and/or the location of the first convolutional layer in the first neural network model. In an embodiment, a structure of the target linear operation may be determined based on the network structure of the first neural network model. The network structure of the first neural network model may be a quantity of sub-network layers included in the first neural network model, types of the sub-network layers, a connection relationship between the sub-network layers, and the location of the first convolutional layer in the first neural network model. The structure of the target linear operation may be a quantity of sub-linear operations included in the target linear operation, types of the sub-linear operations, and a connection relationship between the sub-linear operations. For example, convolutional layers of the neural network models of different network structures may be replaced with linear operations in a model search manner. The neural network models in which the convolutional layers are replaced are trained, to determine optimal or better linear operations corresponding to the convolutional layers in the network structures of the neural network models. The optimal or better linear operation means that precision of a model obtained by training the neural network model in which the convolutional layer is replaced is high. After the first neural network model is obtained, based on the network structure of the first neural network model, a neural network model with a same or similar structure may be selected from neural network models obtained through pre-searching. A linear operation corresponding to a convolutional layer in the neural network model with a same or similar structure is determined as the target linear operation, where a relative location of the foregoing “a convolutional layer” in the neural network model with a same or similar structure is the same as or similar to a relative location of the first convolutional layer in the first neural network model.

The target linear operation may be determined based on the network structure of the first neural network model and the target task implemented by the first neural network model. This is similar to the foregoing manner of performing determining based on the network structure of the first neural network model. Convolutional layers of neural network models that are of different network structures and that implement different target tasks may be replaced with linear operations in a model search manner. The neural network models in which the convolutional layers are replaced are trained, to determine optimal or better linear operations corresponding to the convolutional layers in the network structures of the neural network models. The optimal or better linear operation means that precision of a model obtained by training the neural network model in which the convolutional layer is replaced is high.

The target linear operation may be determined based on the target task implemented by the first neural network model. This is similar to the foregoing manner of performing determining based on the network structure of the first neural network model. Convolutional layers of neural network models that implement different target tasks may be replaced with linear operations in a model search manner. The neural network models in which the convolutional layers are replaced are trained, to determine optimal or better linear operations corresponding to the convolutional layers in the network structures of the neural network models. The optimal or better linear operation means that precision of a model obtained by training the neural network model in which the convolutional layer is replaced is high.

It should be understood that the foregoing manner of determining the target linear operation based on the network structure of the first neural network model and/or the target task is merely an example. Another manner may be used for implementation, provided that model precision of a first neural network model in which the convolutional layer is replaced (that is, a second neural network model) is high. Manners for determining a specific structure and a determining manner of the target linear operation are not limited.

1603: Obtain the second neural network model based on the first neural network model, where the second neural network model is obtained by replacing the first convolutional layer in the first neural network model with the target linear operation.

For descriptions of operation 1603, refer to the descriptions of operation 502. Details are not described herein again.

1604: Perform model training on the second neural network model, to obtain a target neural network model.

For specific descriptions of operation 1604, refer to the description of the process of performing model training on the second neural network model in operation 503. Details are not described herein again.

In this embodiment, a convolutional layer in a to-be-trained neural network is replaced with the target linear operation. The structure of the target linear operation is determined based on the structure of the first neural network model and/or the target task. Compared with a linear operation for replacing a convolutional layer in the existing technology, the linear operation in this embodiment has a structure that is more applicable to the first neural network model and is more flexible. Different linear operations may be designed for different model structures and task types, thereby improving precision of a trained model.

In an embodiment, the target linear operation includes a plurality of sub-linear operations. The target linear operation includes M operation branches. An input of each operation branch is an input of the target linear operation. The M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different.

Compared with a structure of a linear operation for replacing a convolutional layer in the existing technology, the structure of the target linear operation provided in this embodiment is more complex, and may improve precision of a trained model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the target neural network model includes a trained target linear operation, and the method further includes:
replacing the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the method further includes:
fusing, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

This embodiment of this application provides a model training method, including: obtaining a first neural network model, where the first neural network model includes a first convolutional layer, and the first neural network model is used to implement a target task; determining, based on at least one piece of the following information, a target linear operation for replacing the first convolutional layer, where the information includes a network structure of the first neural network model, the target task, and a location of the first convolutional layer in the first neural network model, and the target linear operation is equivalent to a convolutional layer; obtaining a second neural network model based on the first neural network model, where the second neural network model is obtained by replacing the first convolutional layer in the first neural network model with the target linear operation; and performing model training on the second neural network model, to obtain a target neural network model. In the foregoing manner, a convolutional layer in a to-be-trained neural network is replaced with the target linear operation. The structure of the target linear operation is determined based on the structure of the first neural network model, the target task, and/or the location of the first convolutional layer. Compared with a linear operation for replacing a convolutional layer in the existing technology, the linear operation in this embodiment has a structure that is more applicable to the first neural network model and is more flexible. Different linear operations may be designed for different model structures and task types, thereby improving precision of a trained model.

In addition, this application provides a model training method. The method includes:
obtaining a first neural network model, where the first neural network model includes a first convolutional layer;
obtaining a plurality of second neural network models based on the first neural network model, where each second neural network model is obtained by replacing the first convolutional layer in the first neural network model with a target linear operation; the target linear operation is equivalent to one convolutional layer; the target linear operation includes a plurality of sub-linear operations; the target linear operation includes M operation branches; an input of each operation branch is an input of the target linear operation; and the M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different; and
performing model training on the second neural network model, to obtain a target neural network model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the target neural network model includes a trained target linear operation, and the method further includes:
replacing the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the method further includes:
fusing, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

This application provides a model training method. The method includes: obtaining a first neural network model, where the first neural network model includes a first convolutional layer; obtaining a plurality of second neural network models based on the first neural network model, where each second neural network model is obtained by replacing the first convolutional layer in the first neural network model with a target linear operation; the target linear operation is equivalent to one convolutional layer; the target linear operation includes a plurality of sub-linear operations; the target linear operation includes M operation branches; an input of each operation branch is an input of the target linear operation; and the M operation branches meet at least one of the following conditions: an input of at least one of a plurality of sub-linear operations comprised in the M operation branches is an output of a plurality of sub-linear operations of the plurality of sub-linear operations, quantities of sub-linear operations included between at least two of the M operation branches are different, or operation types of sub-linear operations included between at least two of the M operation branches are different; and performing model training on the second neural network model, to obtain a target neural network model. Compared with a structure of a linear operation for replacing a convolutional layer in the existing technology, the structure of the target linear operation provided in this embodiment is more complex, and may improve precision of a trained model.

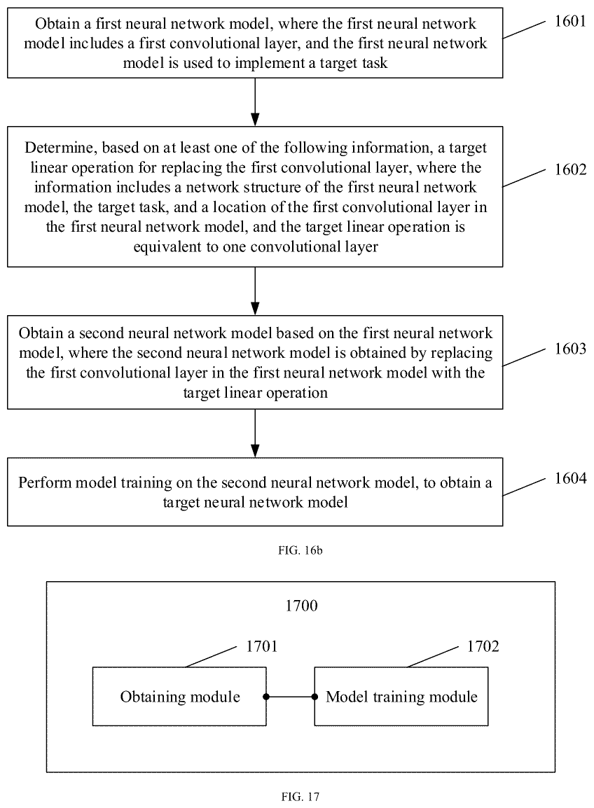

FIG. 17 is a schematic diagram of a model training apparatus 1700 according to an embodiment of this application. As shown in FIG. 17, the model training apparatus 1700 provided in this application includes:
an obtaining module 1701, configured to: obtain a first neural network model, where the first neural network model includes a first convolutional layer, and
obtain a plurality of second neural network models based on the first neural network model, where each second neural network model is obtained by replacing the first convolutional layer in the first neural network model with a linear operation, and the linear operation is equivalent to one convolutional layer, where
for related descriptions of the obtaining module 1701, refer to the descriptions of operation 501 to operation 502 in the foregoing embodiment, and details are not described herein again; and
a model training module 1702, configured to perform model training on the plurality of second neural network models, to obtain a target neural network model, where the target neural network model is a neural network model with highest model precision in a plurality of trained second neural network models.

For related descriptions of the model training module 1702, refer to the descriptions of operation 503 in the foregoing embodiment, and details are not described herein again.

In an embodiment, a receptive field of the convolutional layer equivalent to the linear operation is less than or equal to a receptive field of the first convolutional layer.

In an embodiment, the linear operation includes a plurality of operation branches. An input of each operation branch is an input of the linear operation. Each operation branch includes at least one serial sub-linear operation, and an equivalent receptive field of the at least one serial sub-linear operation is less than or equal to the receptive field of the first convolutional layer.

Alternatively, the linear operation includes one operation branch. The operation branch is used to process input data of the linear operation. The operation branch includes at least one serial sub-linear operation, and an equivalent receptive field of the at least one serial sub-linear operation is less than or equal to the receptive field of the first convolutional layer.

In an embodiment, the linear operation in each second neural network model is different from the first convolutional layer, and linear operations included in different second neural network models are different.

In an embodiment, the convolutional layer equivalent to the linear operation and the linear operation obtain same processing results when processing same data.

In an embodiment, a second neural network model corresponding to the target neural network model is obtained by replacing the first convolutional layer in the first neural network model with a target linear operation. The target neural network model includes a trained target linear operation. The obtaining module is configured to:

replace the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusion module is configured to:
obtain a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtain a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

In an implementation, the obtaining module 1701 in the model training apparatus may be configured to: obtain a first neural network model, where the first neural network model includes a first convolutional layer, and
obtain a second neural network model based on the first neural network model, where the second neural network model is obtained by replacing the first convolutional layer in the first neural network model with a target linear operation; the target linear operation includes a plurality of sub-linear operations; the target linear operation is equivalent to one convolutional layer; the target linear operation includes M operation branches; an input of each operation branch is an input of the target linear operation; and the M operation branches meet at least one of the following conditions:
the plurality of sub-linear operations include at least three operation types,
M is not 3, and
a quantity of sub-linear operations included in at least one of the M operation branches is not equal to 2, where M is a positive integer, or
a quantity of sub-linear operations that are in at least one of the M operation branches and that have an operation type of convolution operations is not 1.

The model training module 1702 may be configured to perform model training on the second neural network model, to obtain a target neural network model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the obtaining module is configured to replace the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusion module is configured to: obtain a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtain a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

An embodiment of this application further provides a model training apparatus. The apparatus includes:
an obtaining module, configured to: obtain a first neural network model, where the first neural network model includes a first convolutional layer;
determine, based on at least one piece of the following information, a target linear operation for replacing the first convolutional layer, where the information includes a network structure of the first neural network model, the target task, and a location of the first convolutional layer in the first neural network model, and the target linear operation is equivalent to one convolutional layer; and
obtain a second neural network model based on the first neural network model, where the second neural network model is obtained by replacing the first convolutional layer in the first neural network model with the target linear operation; and
a model training module, configured to perform model training on the second neural network model, to obtain a target neural network model.

In an embodiment, the target linear operation includes a plurality of sub-linear operations. The target linear operation includes M operation branches. An input of each operation branch is an input of the target linear operation. The M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the obtaining module is configured to replace the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusion module is configured to: obtain a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtain a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

An embodiment of this application further provides a model training apparatus. The apparatus includes:
an obtaining module, configured to: obtain a first neural network model, where the first neural network model includes a first convolutional layer, and
obtain a plurality of second neural network models based on the first neural network model, where each second neural network model is obtained by replacing the first convolutional layer in the first neural network model with a target linear operation; the target linear operation is equivalent to one convolutional layer; the target linear operation includes a plurality of sub-linear operations; the target linear operation includes M operation branches; an input of each operation branch is an input of the target linear operation; and the M operation branches meet at least one of the following conditions:
an input of at least one of a plurality of sub-linear operations included in the M operation branches is an output of a plurality of sub-linear operations of the plurality of sub-linear operations,
quantities of sub-linear operations included in at least two of the M operation branches are different, or
operation types of sub-linear operations included in at least two of the M operation branches are different; and
a model training module, configured to perform model training on the second neural network model, to obtain a target neural network model.

In an embodiment, a receptive field of the convolutional layer equivalent to the target linear operation is less than or equal to a receptive field of the first convolutional layer.

In an embodiment, the target linear operation is different from the first convolutional layer.

In an embodiment, the convolutional layer equivalent to the target linear operation and the target linear operation obtain same processing results when processing same data.

In an embodiment, the target neural network model includes a trained target linear operation, and the obtaining module is configured to:
replace the trained target linear operation in the target neural network model with a second convolutional layer equivalent to the trained target linear operation, to obtain a third neural network model.

In an embodiment, a size of the second convolutional layer is the same as a size of the first convolutional layer.

In an embodiment, the apparatus further includes:
a fusion module, configured to fuse, based on a data processing sequence of a plurality of sub-linear operations included in the trained target linear operation, each sub-linear operation into an adjacent sub-linear operation that follows the sub-linear operation in the sequence, until fusion of a last sub-linear operation in the sequence is completed, to obtain the second convolutional layer equivalent to the target linear operation.

In an embodiment, the trained target linear operation includes a first sub-linear operation and a second sub-linear operation that are adjacent to each other. In the sequence, the second sub-linear operation follows the first sub-linear operation. The first sub-linear operation includes a first operation parameter, and the second sub-linear operation includes a second operation parameter.

The fusing each sub-linear operation into an adjacent sub-linear operation that follows the sub-linear operation in the sequence includes:
obtaining a fusion parameter of the first sub-linear operation, where if input data of the first sub-linear operation is input data of the trained target linear operation, the fusion parameter of the first sub-linear operation is the first operation parameter, or if input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, where if the second sub-linear operation is the last sub-linear operation in the sequence, the fusion parameter of the second sub-linear operation is used as an operation parameter of the second convolutional layer.

In an embodiment, the linear operation includes a plurality of sub-linear operations. An operation type of the plurality of sub-linear operations includes at least one of the following: an addition operation, a null operation, an identity operation, a convolution operation, a batch normalization BN operation, or a pooling operation.

In an embodiment, if the operation type of the second sub-linear operation is the convolution operation or the BN operation, the fusion parameter of the second sub-linear operation is obtained by performing an inner product calculation on the fusion parameter of the first sub-linear operation and the operation parameter of the second sub-linear operation. If the operation type of the second sub-linear operation is the addition operation, the pooling operation, the identity operation, or the null operation, the fusion parameter of the second sub-linear operation is obtained by performing calculation corresponding to the operation type of the second sub-linear operation on the fusion parameter of the first sub-linear operation.

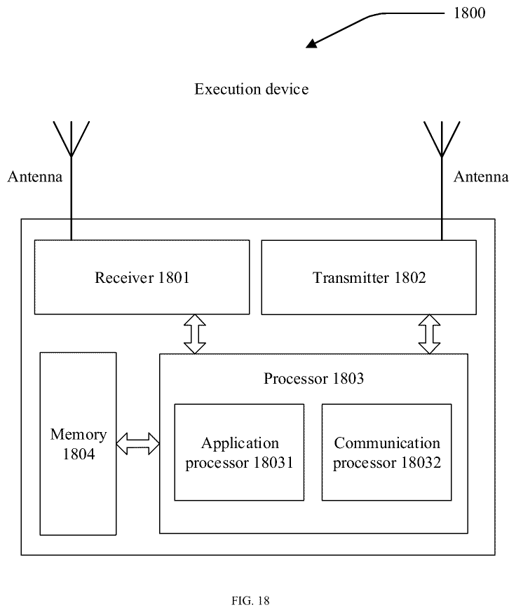

The following describes an execution device provided in an embodiment of this application. FIG. 18 is a schematic diagram of a structure of the execution device according to this embodiment of this application. An execution device 1800 may be a mobile phone, a tablet computer, a laptop computer, a smart wearable device, a server, and the like. This is not limited herein. The execution device 1800 may be provided with a data processing apparatus described in the embodiment corresponding to FIG. 10, to implement a data processing function according to the embodiment corresponding FIG. 10. In an embodiment, the execution device 1800 includes a receiver 1801, a transmitter 1802, a processor 1803, and a memory 1804 (where there may be one or more processors 1803 in the execution device 1800, and FIG. 11 shows an example in which there is one processor). The processor 1803 may include an application processor 18031 and a communication processor 18032. In some embodiments of this application, the receiver 1801, the transmitter 1802, the processor 1803, and the memory 1804 may be connected through a bus or in another manner.

The memory 1804 may include a read-only memory and a random access memory, and provide instructions and data for the processor 1803. A part of the memory 1804 may further include a non-volatile random access memory (NVRAM). The memory 1804 stores a processor, operation instructions, an executable module or a data structure, a subset thereof, or an extended set thereof. The operation instructions may include various operation instructions for implementing various operations.

The processor 1803 controls an operation of the execution device. During specific application, the components of the execution device are coupled together through a bus system. In addition to a data bus, the bus system may further include a power bus, a control bus, a status signal bus, and the like. However, for clear description, various types of buses in the figure are marked as the bus system.

The methods disclosed in the foregoing embodiments of this application may be applied to the processor 1803 or may be implemented by the processor 1803. The processor 1803 may be an integrated circuit chip and has a signal processing capability. In an embodiment, various operations in the foregoing method may be completed by using an integrated logic circuit of hardware in the processor 1803 or instructions in a form of software. The foregoing processor 1803 may be a general purpose processor, a digital signal processor (digital signal processor, DSP), a microprocessor or a microcontroller, or a processor applicable to an AI operation, such as a vision processing unit (vision processing unit, VPU) and a tensor processing unit (tensor processing unit, TPU), and may further include an application-specific integrated circuit (ASIC), a field-programmable gate array (FPGA) or another programmable logic device, a discrete gate or a transistor logic device, or a discrete hardware component. The processor 1803 may implement or perform the methods, the operations, and logical block diagrams that are disclosed in embodiments of this application. The general-purpose processor may be a microprocessor, or the processor may be any conventional processor or the like. Operations of the methods disclosed with reference to embodiments of this application may be directly executed and accomplished by using a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 1804. The processor 1803 reads information in the memory 1804, and completes the operations of the foregoing method in combination with hardware of the processor 1803.

The receiver 1801 may be configured to receive input digit or character information, and generate a signal input related to related setting and function control of the execution device. The transmitter 1802 may be configured to output digital or character information through a first interface. The transmitter 1802 may be further configured to send instructions to a disk group through the first interface, to modify data in the disk group. The transmitter 1802 may further include a display device such as a display.

The execution device may obtain a model obtained through training by using the model training method according to the embodiment corresponding to FIG. 5 or FIG. 16b, and perform model inference.

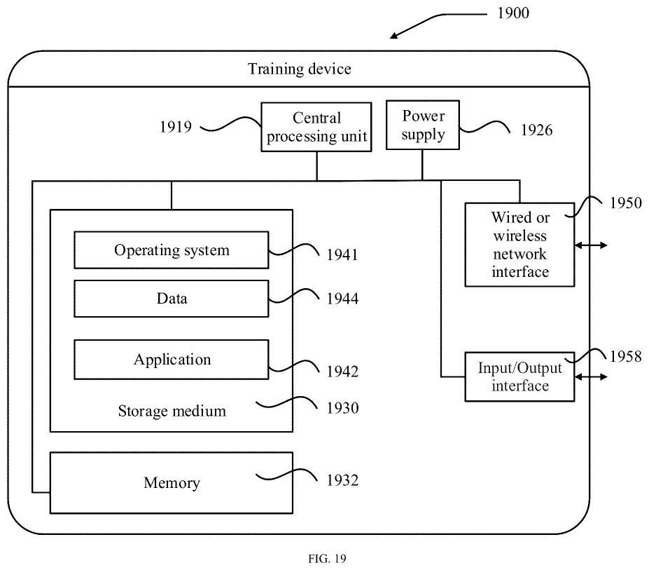

An embodiment of this application further provides a training device. FIG. 19 is a schematic diagram of a structure of the training device according to this embodiment of this application. In an embodiment, a training device 1900 is implemented by one or more servers. The training device 1900 may differ greatly due to different configurations or performance, and may include one or more central processing units (CPUs) 1919 (for example, one or more processors) and a memory 1932, one or more storage media 1930 (for example, one or more massive storage devices) storing an application program 1942 or data 1944. The memory 1932 and the storage media 1930 may be used for temporary storage or persistent storage. A program stored in the storage medium 1930 may include one or more modules (not shown in the figure), and each module may include a series of instruction operations for the training device. Further, the central processing unit 1919 may be configured to communicate with the storage medium 1930, and perform the series of instruction operations in the storage medium 1930 on the training device 1900.

The training device 1900 may further include one or more power supplies 1926, one or more wired or wireless network interfaces 1950, one or more input/output interfaces 1958, or one or more operating systems 1941, such as Windows Server™, Mac OS X™, Unix™, Linux™ and FreeBSD™.

In an embodiment, the training device may perform the model training method according to the embodiment corresponding to FIG. 5 or FIG. 16b.

The model training apparatus 1700 described in FIG. 17 may be a module in the training device. A processor in the training device may perform the model training method performed by the model training apparatus 1700.

An embodiment of this application further provides a computer program product. When the computer program product is run on a computer, the computer is enabled to perform operations performed by the execution device or operations performed by the training device.

An embodiment of this application further provides a computer-readable storage medium. The computer-readable storage medium stores a program used for signal processing. When the program is run on a computer, the computer is enabled to perform operations performed by the execution device or operations performed by the training device.

The execution device, the training device, or the terminal device in embodiments of this application may be a chip. The chip includes a processing unit and a communication unit. The processing unit may be, for example, a processor, and the communication unit may be, for example, an input/output interface, a pin, or a circuit. The processing unit may execute computer-executable instructions stored in a storage unit, so that a chip in the execution device performs the data processing method described in embodiments, or a chip in the training device performs the data processing method described in embodiments. In an embodiment, the storage unit is a storage unit in the chip, for example, a register or a buffer. Alternatively, the storage unit may be a storage unit, such as a read-only memory (ROM), another type of static storage device that can store static information and instructions, or a random access memory (RAM), in a wireless access device but outside the chip.

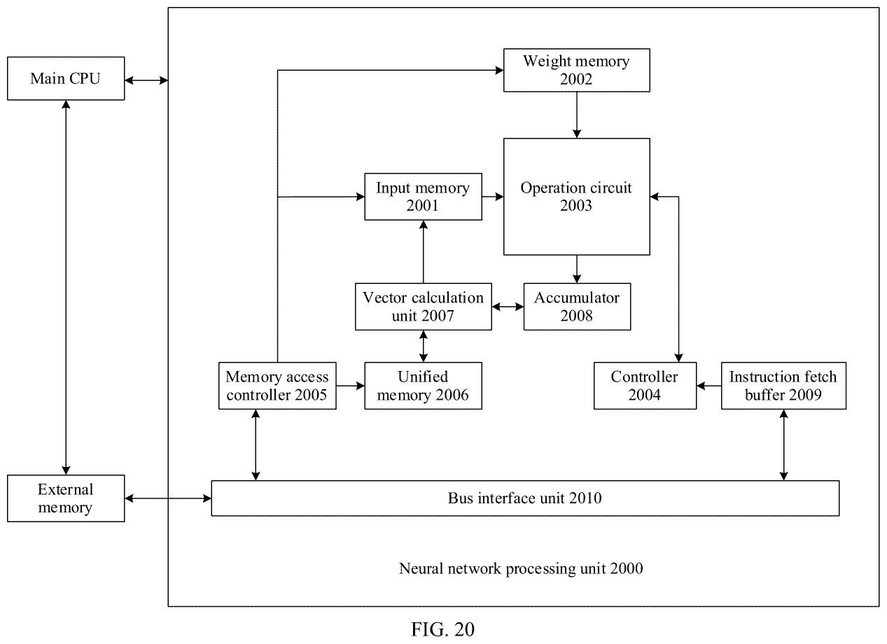

FIG. 20 is a schematic diagram of a structure of a chip according to an embodiment of this application. The chip may be represented as a neural network processing unit NPU 2000. The NPU 2000 is mounted to a host CPU as a coprocessor, and the host CPU allocates a task for the NPU 2000. A core part of the NPU is an operation circuit 2003, and a controller 2004 controls the operation circuit 2003 to extract matrix data in a memory and perform a multiplication operation.

The NPU 2000 may implement, through cooperation between internal components, the model training method according to the embodiment described in FIG. 5, or perform inference on a trained model.

The operation circuit 2003 in the NPU 2000 may perform operations of obtaining the first neural network model and performing model training on the first neural network model.

In some embodiments, the operation circuit 2003 in the NPU 2000 includes a plurality of processing units (processing engine, PE). In some embodiments, the operation circuit 2003 is a two-dimensional systolic array. The operation circuit 2003 may alternatively be a one-dimensional systolic array or another electronic circuit that can perform mathematical operations such as multiplication and addition. In some embodiments, the operation circuit 2003 is a general-purpose matrix processor.

For example, it is assumed that there are an input matrix A, a weight matrix B, and an output matrix C. The operation circuit fetches data corresponding to the matrix B from a weight memory 2002, and buffers the data on each PE in the operation circuit. The operation circuit fetches data of the matrix A from an input memory 2001, to perform a matrix operation on the matrix B, and stores an obtained partial result or an obtained final result of the matrix into an accumulator (accumulator) 2008.

A unified memory 2006 is configured to store input data and output data. Weight data is directly transferred to the weight memory 2002 by using a direct memory access controller (DMAC) 2005. The input data is also transferred to the unified memory 2006 by using the DMAC.

BIU is the abbreviation for bus interface unit. A bus interface unit 2010 is configured to perform interaction between an AXI bus, and the DMAC and an instruction fetch buffer (IFB) 2009.

The bus interface unit (BIU) 2010 is configured for the instruction fetch buffer 2009 to obtain instructions from an external memory, and is further configured for the direct memory access controller 2005 to obtain raw data of the input matrix A or the weight matrix B from the external memory.

The DMAC is mainly configured to transfer input data in the external memory DDR to the unified memory 2006, or transfer the weight data to the weight memory 2002, or transfer the input data to the input memory 2001.

A vector calculation unit 2007 includes a plurality of operation processing units. When necessary, processing, such as vector multiplication, vector addition, an exponential operation, a logarithmic operation, or value comparison, is further performed on an output of the operation circuit 2003. The vector calculation unit 2007 is mainly configured to perform network calculation, such as batch normalization, pixel-level summation, and upsampling on a feature map, at a non-convolutional/fully connected layer in a neural network.

In some embodiments, the vector calculation unit 2007 can store a processed output vector in the unified memory 2006. For example, the vector calculation unit 2007 may apply a linear function or a nonlinear function to the output of the operation circuit 2003, for example, perform linear interpolation on a feature map extracted at a convolutional layer. For another example, the vector calculation unit 2007 may apply a linear function or a nonlinear function to a vector of an accumulated value, to generate an activation value. In some embodiments, the vector calculation unit 2007 generates a normalized value, a pixel-level sum, or a normalized value and a pixel-level sum. In some embodiments, the processed output vector can be used as activation input of the operation circuit 2003, for example, to be used in a subsequent layer in the neural network.

The instruction fetch buffer 2009 connected to the controller 2004 is configured to store instructions used by the controller 2004.

The unified memory 2006, the input memory 2001, the weight memory 2002, and the instruction fetch buffer 2009 are all on-chip memories. The external memory is private for a hardware architecture of the NPU.

The processor mentioned above may be a general-purpose central processing unit, a microprocessor, an ASIC, or one or more integrated circuits for controlling program execution.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected based on actual needs to achieve the objectives of the solutions of embodiments. In addition, in the accompanying drawings of the apparatus embodiments provided by this application, connection relationships between modules indicate that the modules have communication connections with each other, which may be implemented as one or more communication buses or signal cables.

Based on the description of the foregoing embodiments, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, all functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, a software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for enabling a computer device (which may be a personal computer, a training device, a network device, or the like) to perform the methods in embodiments of this application.

All or some of the foregoing embodiments may be implemented by using software, hardware, firmware, or any combination thereof. When software is used to implement embodiments, all or a part of embodiments may be implemented in a form of a computer program product.

The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, training device, or data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or may be a data storage device, such as a training device or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

1. A method of model training, comprising:
obtaining a first neural network model comprising a first convolutional layer;
obtaining a plurality of second neural network models based on the first neural network model, wherein each second neural network model is obtained by replacing the first convolutional layer in the first neural network model with a linear operation that is equivalent to a convolutional layer; and
performing model training on the plurality of second neural network models, to obtain a target neural network model being a neural network model with a highest model precision in a plurality of trained second neural network models.

2. The method according to claim 1, wherein a receptive field of the convolutional layer equivalent to the linear operation is less than or equal to a receptive field of the first convolutional layer.

3. The method according to claim 1, wherein
the linear operation comprises a plurality of operation branches, an input of each operation branch is an input of the linear operation, each operation branch comprises at least one serial sub-linear operation, and an equivalent receptive field of the at least one serial sub-linear operation is less than or equal to the receptive field of the first convolutional layer; or
the linear operation comprises an operation branch configured to process input data of the linear operation, the operation branch comprises at least one serial sub-linear operation, and an equivalent receptive field of the at least one serial sub-linear operation is less than or equal to the receptive field of the first convolutional layer.

4. The method according to claim 1, wherein the linear operation equivalent to the convolutional layer is different from the first convolutional layer, and linear operations comprised in different second neural network models are different from one another.

5. The method according to claim 1, wherein the convolutional layer equivalent to the linear operation and the linear operation obtain same processing results when processing same data.

6. The method according to claim 1, wherein
a second neural network model corresponding to the target neural network model is obtained by replacing the first convolutional layer in the first neural network model with a target linear operation, the target neural network model comprises a trained target linear operation; and the method further comprises:
replacing the trained target linear operation with a second convolutional layer equivalent to the trained target linear operation, to obtain a third neural network model.

7. The method according to claim 6, wherein a size of the second convolutional layer is same as a size of the first convolutional layer.

8. The method according to claim 6, further comprising:
fusing, based on a data processing sequence of a plurality of sub-linear operations comprised in the trained target linear operation, each sub-linear operation into an adjacent sub-linear operation that follows the sub-linear operation in the data processing sequence, until fusion of a last sub-linear operation in the data processing sequence is completed, to obtain the second convolutional layer.

9. The method according to claim 8, wherein
the trained target linear operation comprises a first sub-linear operation and a second sub-linear operation that are adjacent to each other, the second sub-linear operation follows the first sub-linear operation in the data processing sequence, the first sub-linear operation comprises a first operation parameter, and the second sub-linear operation comprises a second operation parameter; and
fusing each sub-linear operation into the adjacent sub-linear operation that follows the sub-linear operation in the data processing sequence comprises:
obtaining a fusion parameter of the first sub-linear operation, wherein when input data of the first sub-linear operation is input data of the trained target linear operation, the fusion parameter of the first sub-linear operation is the first operation parameter, or when input data of the first sub-linear operation is output data of a third sub-linear operation that is adjacent to the first sub-linear operation and that is followed by the first sub-linear operation in the sequence, the fusion parameter of the first sub-linear operation is obtained based on a fusion parameter of the third sub-linear operation and the first operation parameter; and
obtaining a fusion parameter of the second sub-linear operation based on the fusion parameter of the first sub-linear operation, the second operation parameter, and an operation type of the second sub-linear operation, wherein when the second sub-linear operation is the last sub-linear operation in the data processing sequence, the fusion parameter of the second sub-linear operation is used as an operation parameter of the second convolutional layer.

10. The method according to claim 1, wherein the linear operation comprises a plurality of sub-linear operations, and an operation type of the plurality of sub-linear operations comprises at least one of: an addition operation, a null operation, an identity operation, a convolution operation, a batch normalization (BN) operation, or a pooling operation.

11. The method according to claim 9, wherein
when the operation type of the second sub-linear operation is a convolution operation or a batch normalization (BN) operation, the fusion parameter of the second sub-linear operation is obtained by performing an inner product calculation on the fusion parameter of the first sub-linear operation and the operation parameter of the second sub-linear operation; or
when the operation type of the second sub-linear operation is an addition operation, a pooling operation, an identity operation, or a null operation, the fusion parameter of the second sub-linear operation is obtained by performing calculation corresponding to the operation type of the second sub-linear operation on the fusion parameter of the first sub-linear operation.

12. A method of model training, comprising:
obtaining a first neural network model comprising a first convolutional layer used to implement a target task;
determining a target linear operation for replacing the first convolutional layer based on at least one of: a network structure of the first neural network model, the target task, or a location of the first convolutional layer in the first neural network model, wherein the target linear operation is equivalent to a convolutional layer;
obtaining a second neural network model based on the first neural network model, wherein the second neural network model is obtained by replacing the first convolutional layer in the first neural network model with the target linear operation; and
performing model training on the second neural network model, to obtain a target neural network model.

13. The method according to claim 12, wherein
the target linear operation comprises a plurality of sub-linear operations and M operation branches, an input of each operation branch is an input of the target linear operation, and the M operation branches meet at least one of the following:
an input of at least one of a first plurality of sub-linear operations comprised in the M operation branches is an output of a second plurality of sub-linear operations of the plurality of sub-linear operations;
quantities of sub-linear operations comprised in at least two of the M operation branches are different from one another; or
operation types of sub-linear operations comprised in the at least two of the M operation branches are different from one another.

14. The method according to claim 12, wherein a receptive field of the convolutional layer equivalent to the target linear operation is less than or equal to a receptive field of the first convolutional layer.

15. The method according to claim 12, wherein the target linear operation is different from the first convolutional layer.

16. The method according to claim 12, wherein the convolutional layer equivalent to the target linear operation and the target linear operation obtain same processing results when processing same data.

17. The method according to claim 12, wherein
the target neural network model comprises a trained target linear operation; and
the method further comprises:
replacing the trained target linear operation in the target neural network model with a second convolutional layer equivalent to the trained target linear operation, to obtain a third neural network model.

18. A model training apparatus, comprising:
a processor; and
a memory coupled to the processor to store instructions, which when executed by the processor, cause the processor to:
obtain a first neural network model comprising a first convolutional layer;
obtain a plurality of second neural network models based on the first neural network model, wherein each second neural network model is obtained by replacing the first convolutional layer in the first neural network model with a linear operation that is equivalent to a convolutional layer; and
perform model training on the plurality of second neural network models, to obtain a target neural network model being a neural network model with a highest model precision in a plurality of trained second neural network models.
